(19) United States
(12) Patent Application Publication
(10) Pub. No.: US 2025/0341795 A1
(43) Pub. Date: Nov. 6, 2025

(54) EXPOSURE HEAD

(71) Applicant: CANON KABUSHIKI KAISHA, Tokyo (JP)

(72) Inventors: HIROKI TAKANO, Saitama (JP); YUUTA SAKURAI, Chiba (JP); YU OGURO, Ibaraki (JP); AKIHISA YAMADA, Ibaraki (JP); RYO AIHARA, Chiba (JP); KENJI SUZUKI, Chiba (JP); HIROSHI NAKAHATA, Chiba (JP); TAKEHIRO ISHIDATE, Tokyo (JP)

(21) Appl. No.: 19/079,907

(22) Filed: Mar. 14, 2025

(30) Foreign Application Priority Data
May 1, 2024 (JP) 2024-074286

(51) Int. Cl. G03G 15/04; B41J 2/45; G02B 19/00

(52) U.S. Cl. CPC G03G 15/04063; B41J 2/45; G02B 19/0009; G02B 19/0047

(57) ABSTRACT

An exposure head includes: a light emitting chip including a plurality of light emitting portions arranged in a rotational axis direction of a photosensitive member and configured to emit light to expose the photosensitive member; a board on which the light emitting chip is mounted; a lens configured to condense the light emitted by the light emitting chip onto a surface of the photosensitive member; a housing configured to hold the board and the lens; a first adhesive configured to make the housing and the board adhere to each other, the first adhesive being cured at a first rate and having a cured elastic modulus of a first elastic modulus; and a second adhesive configured to make the housing and the board adhere to each other, the second adhesive being cured at a second rate and having a cured elastic modulus of a second elastic modulus, in which the second rate is higher than the first rate, and the first elastic modulus is higher than the second elastic modulus.

### BACKGROUND OF THE INVENTION

### Field of the Invention

The present invention relates to an exposure head that exposes an image bearing member.

### Description of the Related Art

An electrophotographic image forming apparatus according to a related art forms an electrostatic latent image by selectively exposing a photosensitive member, and forms an image by developing the formed electrostatic latent image with toner. As an exposure device of such an image forming apparatus, an LED exposure device of an LED array system is known. The LED exposure device described above generally includes a printed circuit board on which light emitting chips are arranged, a lens array, and a housing in which the printed circuit board and the lens array adhere and are fixed to each other by an adhesive after the printed circuit board and the lens array are positioned.

### SUMMARY OF THE INVENTION

The present invention provides an exposure head capable of suppressing deterioration in optical performance due to displacement of a board with respect to a housing.

An exposure head according to the present invention is an exposure head configured to expose a photosensitive member, the exposure head including: a light emitting chip including a plurality of light emitting portions arranged in a rotational axis direction of the photosensitive member and configured to emit light to expose the photosensitive member; a board on which the light emitting chip is mounted; a lens configured to condense the light emitted by the light emitting chip onto a surface of the photosensitive member; a housing configured to hold the board and the lens; a first adhesive configured to make the housing and the board adhere to each other, the first adhesive being cured at a first rate and having a cured elastic modulus of a first elastic modulus; and a second adhesive configured to make the housing and the board adhere to each other, the second adhesive being cured at a second rate and having a cured elastic modulus of a second elastic modulus, in which the second rate is higher than the first rate, and the first elastic modulus is higher than the second elastic modulus.

Further features of the present invention will become apparent from the following description of exemplary embodiments with reference to the attached drawings.

### BRIEF DESCRIPTION OF THE DRAWINGS

FIG. 1 is a perspective view of an image forming apparatus according to an embodiment of the present invention;

FIG. 2 is a schematic view of a state in which an exposure head of the image forming apparatus according to the embodiment of the present invention is in proximity to a photosensitive drum;

FIG. 3 is a schematic view of a state in which the exposure head of the image forming apparatus according to the embodiment of the present invention is separated from the photosensitive drum;

FIG. 4 is a perspective view of the image forming apparatus according to the embodiment of the present invention in a state in which a front cover is opened;

FIG. 5 is an enlarged perspective view of a state in which an inner door of the image forming apparatus according to the embodiment of the present invention is opened;

FIG. 6 is an enlarged perspective view of a state in which a drum unit of the image forming apparatus according to the embodiment of the present invention is pulled out;

FIG. 7 is an enlarged perspective view of a state in which a developing unit of the image forming apparatus according to the embodiment of the present invention is pulled out;

FIG. 8 is a perspective view of a state in which the inner door of a cartridge tray of the image forming apparatus according to the embodiment of the present invention is closed;

FIG. 9 is a perspective view of a state in which the inner door of the cartridge tray of the image forming apparatus according to the embodiment of the present invention is opened;

FIG. 10 is a cross-sectional view of the exposure head according to the embodiment of the present invention;

FIG. 11 is a perspective view of the exposure head according to the embodiment of the present invention when viewed from above;

FIG. 12 is a perspective view of the exposure head according to the embodiment of the present invention when viewed from below;

FIGS. 13A, 13B, 13C, 13D, and 13E are schematic views of a board and a lens array of the exposure head according to the embodiment of the present invention;

FIG. 14 is a perspective view of the board of the exposure head according to the embodiment of the present invention when viewed from a surface side on which a light emitting diode (LED) is mounted;

FIG. 15 is a perspective view of the board of the exposure head according to the embodiment of the present invention when viewed from a surface side on which a connector is mounted;

FIG. 16 is a perspective view of the board of the exposure head according to the embodiment of the present invention in a state of being assembled to a housing when viewed from the surface side on which the LED is mounted;

FIG. 17 is a perspective view of the board of the exposure head according to the embodiment of the present invention in a state of being assembled to the housing when viewed from the surface side on which the connector is mounted;

FIG. 18 is a perspective view of a state in which the board and the lens array of the exposure head according to the embodiment of the present invention are assembled to the housing;

FIG. 19 is a perspective view of the cartridge tray of the image forming apparatus according to the embodiment of the present invention;

FIG. 20 is a bottom view of the cartridge tray and an elevating duct of the image forming apparatus according to the embodiment of the present invention;

FIG. 21 is a cross-sectional view taken along line X-X of FIG. 19 in a state in which the exposure head according to the embodiment of the present invention is positioned at an exposure position;

FIG. 22 is a cross-sectional view taken along line X-X of FIG. 19 in a state in which the exposure head according to the embodiment of the present invention is positioned at a retracted position;

FIG. 23 is a cross-sectional view taken along line Y-Y of FIG. 19 in a state in which the exposure head according to the embodiment of the present invention is positioned at the exposure position;

FIG. 24 is a cross-sectional view taken along line Y-Y of FIG. 19 in a state in which the exposure head according to the embodiment of the present invention is positioned at the retracted position;

FIG. 25 is a cross-sectional view of a part of the image forming apparatus according to the embodiment of the present invention;

FIG. 26 is a perspective view of the exposure head, the elevating duct, and a rotating arm according to the embodiment of the present invention;

FIG. 27 is a side view of a state in which the inner door of a developing stay of the image forming apparatus according to the embodiment of the present invention is closed;

FIG. 28 is a side view of a state in which the inner door of the developing stay of the image forming apparatus according to the embodiment of the present invention is opened;

FIG. 29 is a cross-sectional view taken along line X-X of FIG. 19;

FIG. 30 is a cross-sectional view of the exposure head, the photosensitive drum, and the rotating arm according to the embodiment of the present invention;

FIG. 31 is a cross-sectional perspective view illustrating positioning of front surface sides of the exposure head and the photosensitive drum according to the embodiment of the present invention;

FIG. 32 is a cross-sectional perspective view illustrating positioning of back surface sides of the exposure head and the photosensitive drum according to the embodiment of the present invention;

FIG. 33 is a perspective view of a state in which the exposure head according to the embodiment of the present invention is removed from the elevating duct when viewed from the right;

FIG. 34 is a cross-sectional view of a state in which the exposure head according to the embodiment of the present invention is removed from the elevating duct;

FIG. 35 is a perspective view of a state in which the exposure head according to the embodiment of the present invention is removed from the elevating duct when viewed from the left;

FIG. 36 is a perspective view of a state in which the exposure head according to the embodiment of the present invention is placed on the elevating duct when viewed from the right;

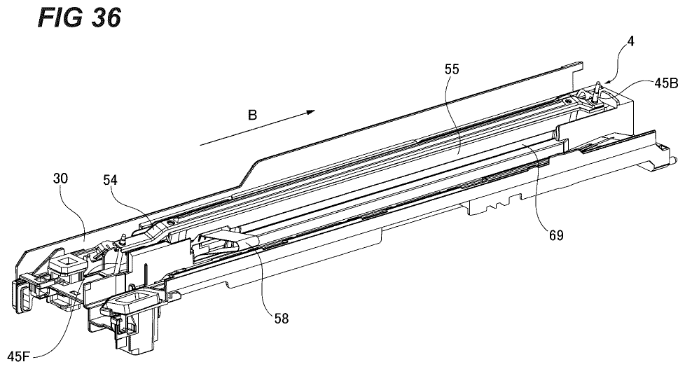

FIG. 37 is a cross-sectional view of a cross section taken along a plane orthogonal to a front-rear direction in a state in which the exposure head according to the embodiment of the present invention is placed on the elevating duct;

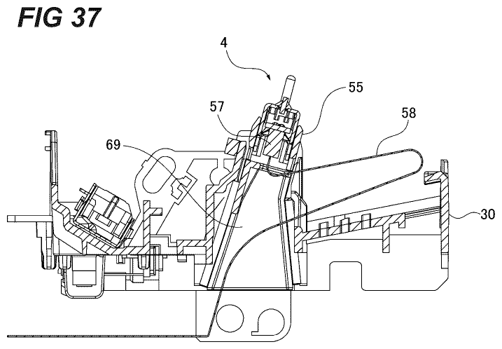

FIG. 38 is a perspective view of the exposure head according to the embodiment of the present invention when viewed from the left in a state in which the exposure head is placed on the elevating duct;

FIG. 39 is a cross-sectional view of a cross section taken along a plane orthogonal to a left-right direction in a state in which the exposure head according to the embodiment of the present invention is placed on the elevating duct;

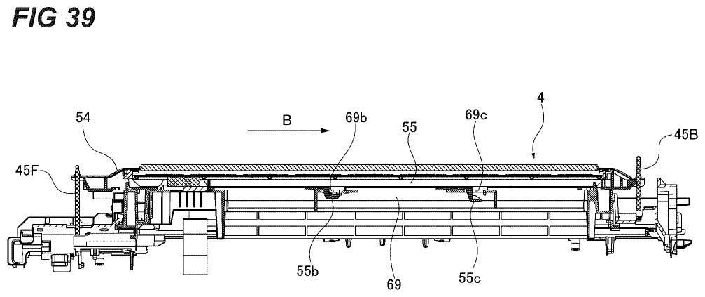

FIG. 40 is a cross-sectional view of a part of a state in which the exposure head according to the embodiment of the present invention is placed on the elevating duct;

FIG. 41 is a perspective view of the exposure head according to the embodiment of the present invention attached to the elevating duct when viewed from the right;

FIG. 42 is a perspective view of the exposure head according to the embodiment of the present invention attached to the elevating duct when viewed from the left;

FIG. 43 is a cross-sectional view taken along line W-W of FIG. 29;

FIG. 44 is an enlarged cross-sectional view of a part of the image forming apparatus according to the embodiment of the present invention;

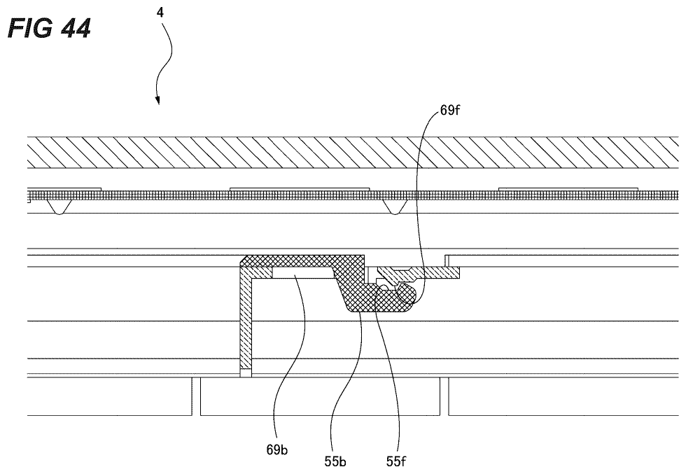

FIG. 45 is a bottom view of the exposure head according to the embodiment of the present invention before application of a third adhesive;

FIG. 46 is a perspective view of the exposure head according to the embodiment of the present invention before the application of the third adhesive;

FIG. 47 is a plan view of the exposure head according to the embodiment of the present invention before application of a sixth adhesive;

FIG. 48 is a perspective view of the exposure head according to the embodiment of the present invention before the application of the sixth adhesive;

FIG. 49 is a bottom view of the exposure head according to the embodiment of the present invention after the application of the third adhesive;

FIG. 50 is a perspective view of the exposure head according to the embodiment of the present invention after the application of the third adhesive;

FIG. 51 is a plan view of the exposure head according to the embodiment of the present invention after the application of the sixth adhesive; and

FIG. 52 is a perspective view of the exposure head according to the embodiment of the present invention after the application of the sixth adhesive.

### DESCRIPTION OF THE EMBODIMENTS

Hereinafter, embodiments will be described in detail with reference to the drawings.

### Configuration of Image Forming Apparatus

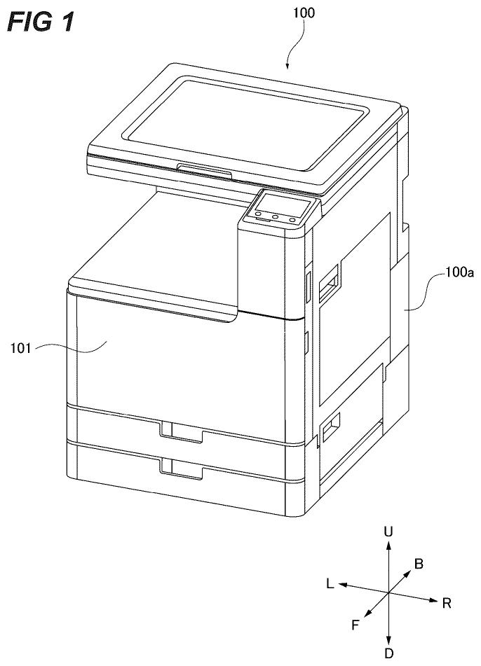

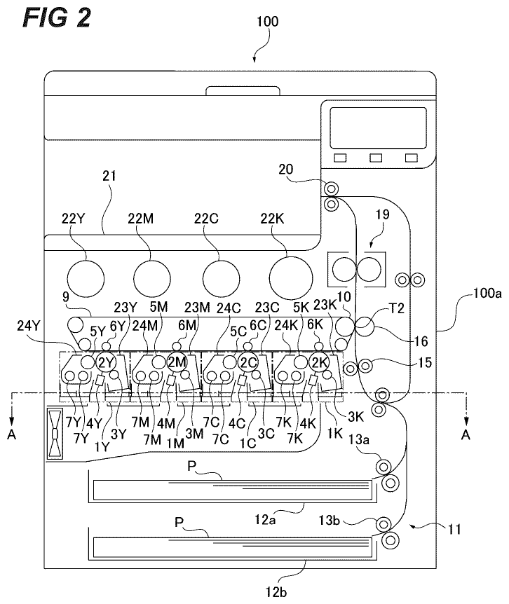

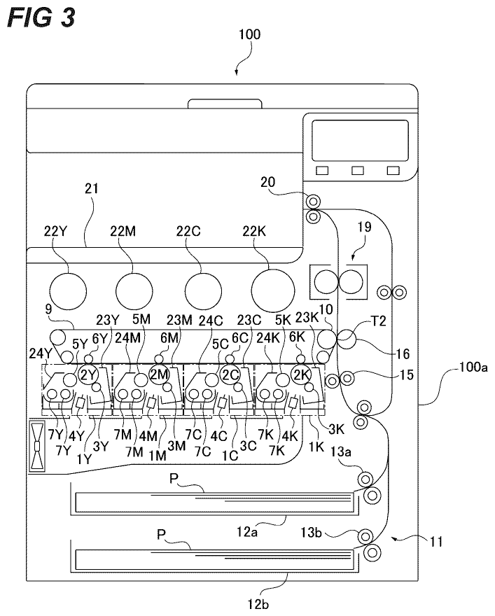

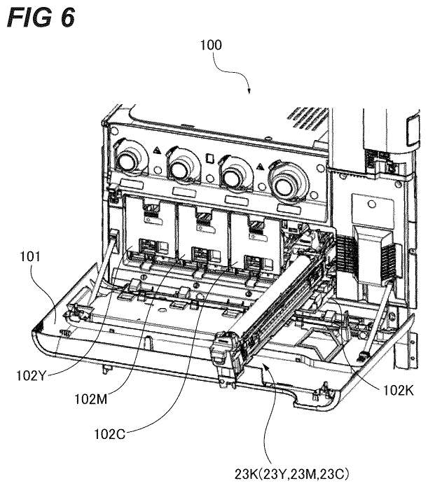

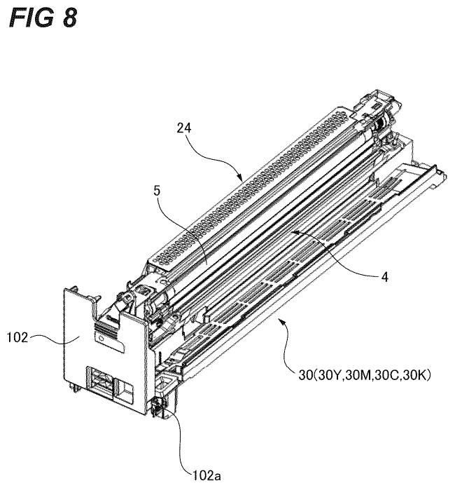

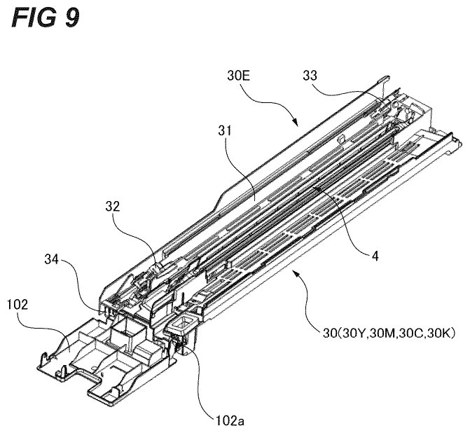

A configuration of an image forming apparatus 100 according to an embodiment of the present invention will be described in detail with reference to FIGS. 1 to 9, 23, 24, and 30.

Here, a forward direction is denoted by F, a rearward direction is denoted by B, a rightward direction is denoted by R, a leftward direction is denoted by L, an upward direction is denoted by U, and a downward direction is denoted by D. Further, a front side is defined as a front surface side, and a rear side is defined as a back side or a back surface side. In addition, an upward direction in a vertical direction that is perpendicular to a front-rear direction and a left-right direction is defined as the upward direction, and a downward direction in the vertical direction that is perpendicular to the front-rear direction and the left-right direction is defined as the downward direction.

An axial direction of a photosensitive drum 2 and a longitudinal direction of an exposure head 4 are the front-rear direction. One end sides of photosensitive drums 2Y, 2M, 2C, and 2K in the axial direction are the front sides, and the other end sides of the photosensitive drums 2Y, 2M, 2C, and 2K in the axial direction are the rear sides.

Here, the image forming apparatus 100 is exemplified by a so-called tandem type color multifunction peripheral (MFP) including the plurality of photosensitive drums 2Y, 2M, 2C, and 2K and including a reading device. The image forming apparatus 100 may be a copying machine that does not include the reading device, a color image forming apparatus including one photosensitive drum, or an image forming apparatus that forms a monochrome image. Alternatively, the image forming apparatus 100 may be a single-color mono-color printer or a full-color printer of five or more colors using spot color toner. In this case, the image forming apparatus 100 may include the exposure head 4 corresponding to the number of colors.

Specifically, the image forming apparatus 100 includes image forming portions 1Y, 1M, 1C, and 1K, primary transfer rollers 6Y, 6M, 6C, and 6K, an intermediate transfer belt 9, a feeding portion 11, a secondary transfer roller 16, and a fixing device 19. The image forming apparatus 100 includes a discharge roller 20, a discharge tray 21, toner bottles 22Y, 22M, 22C, and 22K, cartridge trays 30Y, 30M, 30C, and 30K, a rotating arm 65, and an elevating duct 69.

The image forming apparatus 100 further includes an apparatus body 100a, a front cover 101, and inner doors 102Y, 102M, 102C, and 102K. Y (yellow), M (magenta), C (cyan), and K (black) represent toner colors. In the following description, when necessary, Y, M, C, and K appended to the end of the same reference numeral may be omitted, and only the reference numeral may be used.

The image forming portion 1Y forms a yellow toner image. The image forming portion 1M forms a magenta toner image. The image forming portion 1C forms a cyan toner image. The image forming portion 1K forms a black toner image. The image forming portion 1 includes the exposure head 4, a drum unit 23, and a developing unit 24.

The exposure head 4 has an elongated shape (longitudinal shape) extending in the axial direction of the photosensitive drum 2. The exposure head 4 exposes the photosensitive drum 2 of the drum unit 23 by a so-called “bottom exposure method” in which the photosensitive drum 2 is exposed from below. The exposure head 4 forms an electrostatic latent image on the photosensitive drum 2 by exposing the photosensitive drum 2 charged by a charging roller 3 of the drum unit 23. The exposure head 4 is a light emitting diode (hereinafter, referred to as LED) exposure head.

The drum unit 23 is a cartridge to be replaced by a user or an operator such as a maintenance person. Since the drum unit 23 deteriorates due to repetition of an image forming process, the drum unit 23 has a form of a replaceable unit or a detachably attachable unit for maintenance. The drum unit 23 is a drum cartridge including the photosensitive drum 2, the charging roller 3, and a cleaning device (not illustrated) that are integrally unitized. The drum unit 23 does not have to include the charging roller 3 and the cleaning device.

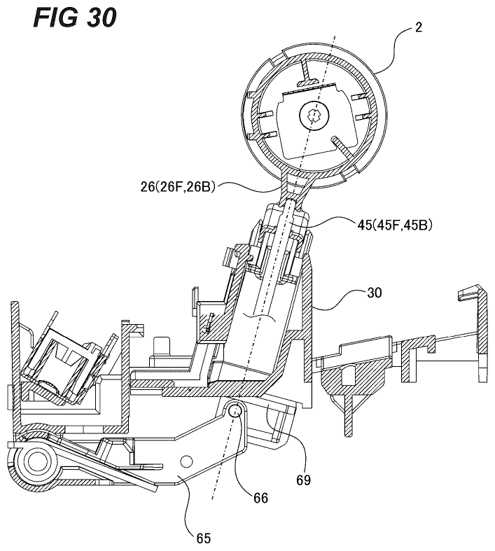

The drum unit 23 includes a drum bearing 26 that axially supports both end portions of the photosensitive drum 2 in the axial direction (see FIG. 30). The drum bearing 26 includes a recessed engagement portion 26F and a recessed engagement portion 26B provided at positions facing a positioning pin 45F and a positioning pin 45B of the exposure head 4 described below. The engagement portion 26F and the engagement portion 26B are engaged with the positioning pin 45F and the positioning pin 45B. Inclined surfaces are formed at edge portions of the engagement portion 26F and the engagement portion 26B so as not to ride on recessed edges when the engagement portion 26F and the engagement portion 26B are engaged with the positioning pin 45F and the positioning pin 45B.

The photosensitive drum 2 as an image bearing member is turnably supported by a frame body of the drum unit 23. The photosensitive drum 2 is an example of a photosensitive member, and may be a photosensitive belt.

The charging roller 3 charges the photosensitive drum 2.

Since the developing unit 24 deteriorates due to repetition of the image forming process, the developing unit 24 has a form of a replaceable unit or a detachably attachable unit for maintenance. The developing unit 24 develops the electrostatic latent image formed on the photosensitive drum 2 by the exposure head 4 with the toner to form the toner image on the photosensitive drum 2. The developing unit 24 includes a developing sleeve 5 and a screw 7. The developing unit 24 is a cartridge in which the developing sleeve 5 and the screw 7 are integrated with each other, and is removed from the apparatus body of the image forming apparatus 100 when replaced by the operator.

The developing sleeve 5 bears a developer supplied by the screw 7.

The screw 7 stirs the developer and supplies the developer to the developing sleeve 5.

The primary transfer roller 6 sequentially primarily transfers the toner image formed on the photosensitive drum 2 by the developing unit 24 to the intermediate transfer belt 9.

The intermediate transfer belt 9 is disposed above the image forming portion 1. The toner image formed on the photosensitive drum 2 is primarily transferred to the intermediate transfer belt 9 by the primary transfer roller 6. The intermediate transfer belt 9 conveys the primarily transferred toner image to the secondary transfer roller 16.

The feeding portion 11 feeds a recording sheet to the secondary transfer roller 16. The feeding portion 11 includes a sheet cassette 12a, a sheet cassette 12b, a feeding roller 13a, a feeding roller 13b, and a registration roller 15.

The sheet cassette 12a is disposed below the image forming portion 1. In the sheet cassette 12a, recording sheets P are stacked and stored.

The sheet cassette 12b is disposed below the image forming portion 1. In the sheet cassette 12b, the recording sheets P are stacked and stored.

The feeding roller 13a feeds the recording sheets P stored in the sheet cassette 12a one by one to the registration roller 15.

The feeding roller 13b feeds the recording sheets P stored in the sheet cassette 12b one by one to the registration roller 15.

The registration roller 15 conveys the recording sheet P fed by the feeding roller 13a or the feeding roller 13b to a secondary transfer portion T2 at a predetermined timing.

The secondary transfer roller 16 secondarily transfers, to the recording sheet P conveyed from the feeding portion 11, the toner image primarily transferred to the intermediate transfer belt 9 by the primary transfer roller 6. The secondary transfer roller 16 conveys, to the fixing device 19, the recording sheet P to which the toner image has been secondarily transferred.

The fixing device 19 applies heat and pressure to the recording sheet P to which the toner image conveyed by the secondary transfer roller 16 has been secondarily transferred, thereby fixing the toner image on the recording sheet P. The fixing device 19 conveys the recording sheet P on which the toner image has been fixed to the discharge roller 20.

The discharge roller 20 discharges the recording sheet P conveyed by the fixing device 19 to the discharge tray 21.

The discharge tray 21 is disposed above the toner bottle 22. The recording sheet P discharged by the discharge roller 20 is stacked on the discharge tray 21.

The toner bottle 22 is a replaceable unit that can be attached to and detached from the image forming apparatus 100 and is disposed above the intermediate transfer belt 9. The toner bottle 22 stores toner for replenishment. Each of the toner bottles 22 resupplies an appropriate amount of toner to each of the developing units 24 in a timely manner by a toner resupply mechanism (not illustrated).

The cartridge tray 30 supports the drum unit 23 and the developing unit 24. The cartridge tray 30 is guided and movable in the axial direction of the photosensitive drum 2. The cartridge tray 30 turnably and axially supports a rotation shaft 102a of the inner door 102. A detailed configuration of the cartridge tray 30 is described below. The cartridge tray 30 is not limited to a configuration in which the cartridge tray 30 is provided for each image forming portion 1.

The rotating arm 65 supports both end portions of the elevating duct 69 in a longitudinal direction from below.

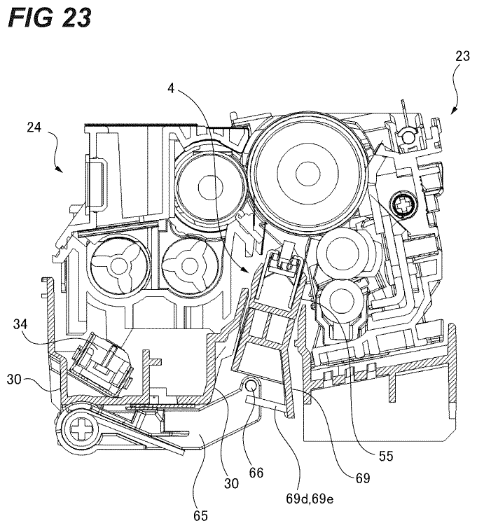

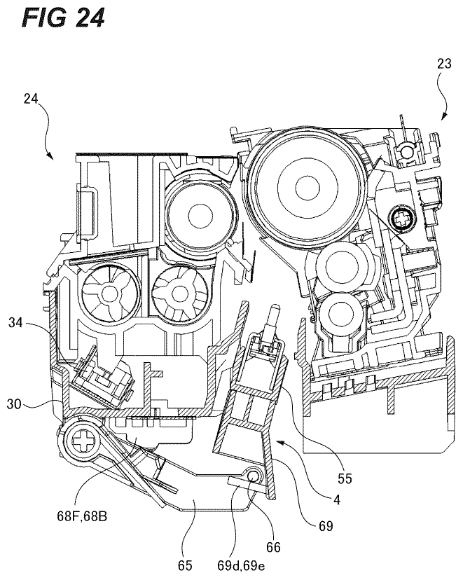

The elevating duct 69 is movably provided between a developing support member 301 described below and a drum support member 302 of the cartridge tray 30, and detachably supports the exposure head 4. The elevating duct 69 is movable in a direction orthogonal to the axial direction of the photosensitive drum 2 together with the exposure head 4 by the rotating arm 65. The elevating duct 69 moves to an exposure position illustrated in FIG. 23 for exposing the photosensitive drum 2 and a retracted position illustrated in FIG. 24 retracted from the exposure position by the rotation of the rotating arm 65.

Similarly to the exposure head 4, the elevating duct 69 has a longitudinal shape extending in the axial direction (front-rear direction) of the photosensitive drum 2. The elevating duct 69 has openings on upper and lower sides at the center in the longitudinal direction. The elevating duct 69 forms, together with the cartridge tray 30, an opening portion 64 that communicates with an opening portion of a duct unit (not illustrated) for blowing air taken in from the outside of the image forming apparatus 100 toward a board 50 of the exposure head 4 through the elevating duct 69. A detailed configuration of the elevating duct 69 is described below.

The apparatus body 100a forms a housing of the image forming apparatus 100.

The front cover 101 is provided on a front side of the apparatus body 100a, and forms a front side exterior of the image forming apparatus 100. The front cover 101 is provided to be rotatable with respect to the apparatus body 100a by a hinge (not illustrated). The front cover 101 is provided on a front side of the inner door 102 in the axial direction of the photosensitive drum 2. In a closed state illustrated in FIG. 1, the front cover 101 covers all the plurality of inner doors 102 arranged in the left-right direction.

The inner door 102 is provided on a front side of the cartridge tray 30 so as to be rotatable with respect to the cartridge tray 30 by a hinge (not illustrated). The inner door 102 covers front sides of the drum unit 23 and the developing unit 24. The inner door 102 is a member necessary for protecting each unit and making the photosensitive drum 2 difficult to be exposed to light in a process other than the image forming process.

The inner door 102 includes the rotation shaft 102a and a link engagement portion 102b.

The rotation shaft 102a is a rotation center when the inner door 102 rotates with respect to the cartridge tray 30.

The link engagement portion 102b is provided below the rotation shaft 102a in a direction orthogonal to the axial direction of the photosensitive drum 2 when the inner door 102 is closed. The link engagement portion 102b is engaged with a developing stay link 34.

### Configuration of Exposure Head

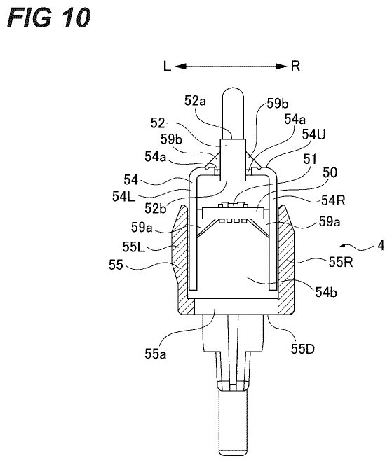

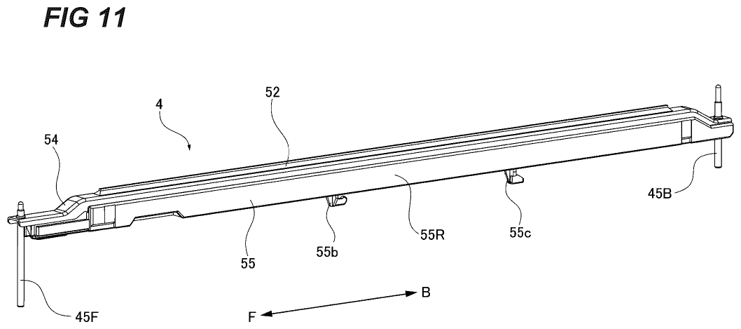

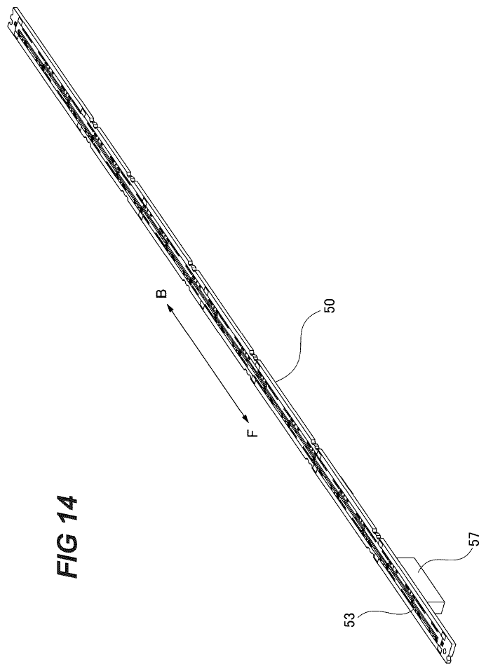

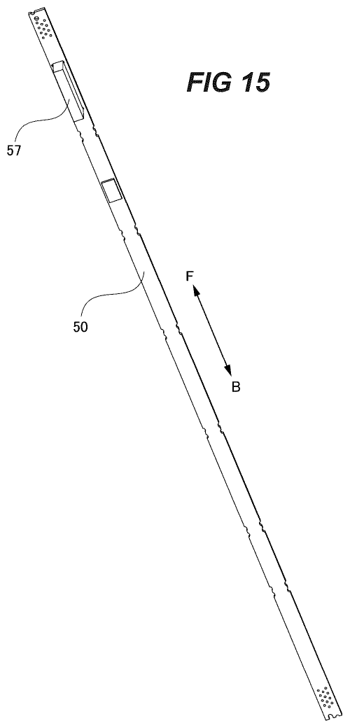

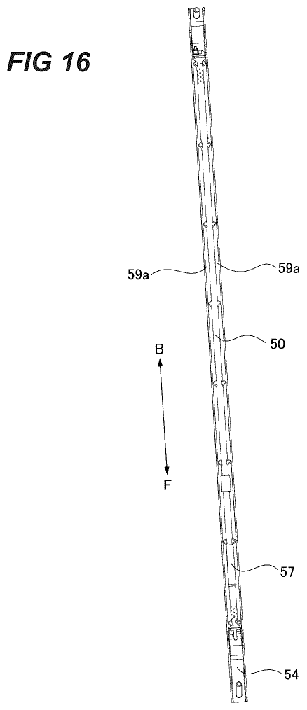

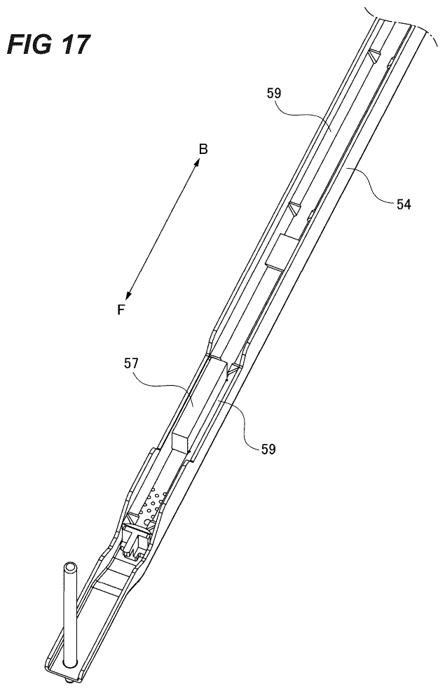

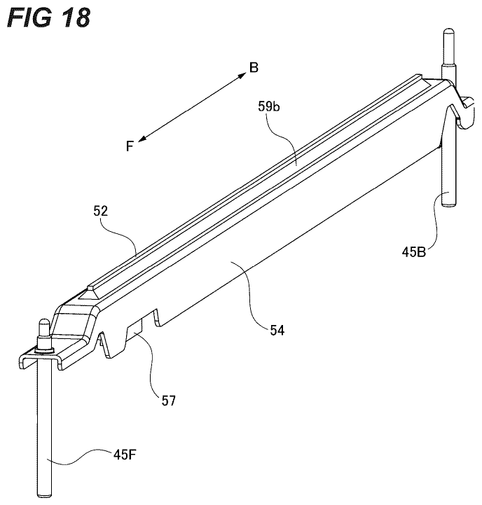

A configuration of the exposure head 4 according to the embodiment of the present invention will be described in detail with reference to FIGS. 10 to 18, 38, and 40.

The exposure head 4 includes the positioning pin 45B, the positioning pin 45F, the board 50, a lens array 52, LED chips 53, a housing 54, a housing support member 55, and a flexible flat cable (FFC) connector 57.

The positioning pin 45B is a conductive member having conductivity, and is caulked to the housing 54 and electrically connected to the housing 54. The positioning pin 45B is provided on a rear side of the lens array 52 in a longitudinal direction of the housing 54, and protrudes to both sides of the housing 54 in a direction parallel to an optical axis direction of the lens array 52.

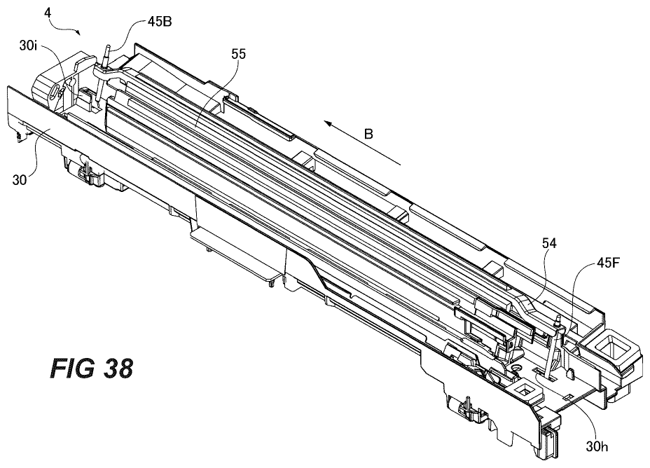

The positioning pin 45B abuts on the drum bearing 26 of the drum unit 23 in a movement direction of the elevating duct 69 from the retracted position to the exposure position, thereby providing a gap between the lens array 52 and the photosensitive drum 2. When the exposure head 4 is slid in a direction of an arrow B in FIG. 38, a lower end portion of the positioning pin 45B is additionally fitted to an auxiliary fitting portion 30i of the cartridge tray 30.

When the exposure head 4 is slid in the direction of the arrow B in FIG. 38, the positioning pin 45B comes into contact with a conductive member 251 of the cartridge tray 30 described below, thereby connecting the exposure head 4 and the image forming apparatus 100 to the ground. The positioning pin 45B is not limited to being provided in the housing 54 by caulking, and may be welded to the housing 54.

The positioning pin 45F is a conductive member having conductivity, and is caulked to the housing 54 and electrically connected to the housing 54. The positioning pin 45F is provided on a front side of the lens array 52 in the longitudinal direction of the housing 54, and protrudes to both sides of the housing 54 in the direction parallel to the optical axis direction of the lens array 52.

The positioning pin 45F abuts on the drum bearing 26 of the drum unit 23 in the movement direction of the elevating duct 69 from the retracted position to the exposure position, thereby providing a gap between the lens array 52 and the photosensitive drum 2. When the exposure head 4 is slid in the direction of the arrow B in FIG. 38, a lower end portion of the positioning pin 45F is additionally fitted to an auxiliary fitting portion 30h of the cartridge tray 30.

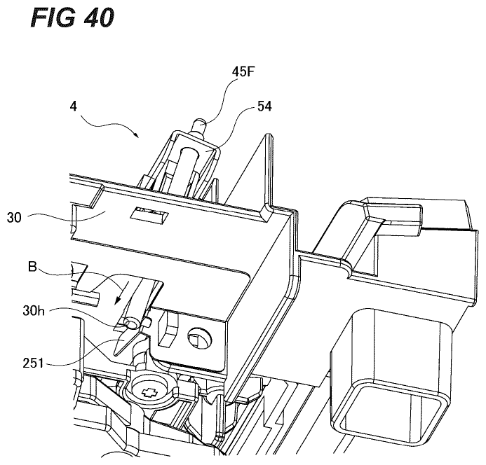

When the exposure head 4 is slid in the direction of the arrow B in FIG. 38, as illustrated in FIG. 40, the positioning pin 45F comes into contact with the conductive member 251 of the cartridge tray 30, thereby connecting the exposure head 4 and the image forming apparatus 100 to the ground. The positioning pin 45F is not limited to being provided in the housing 54 by caulking, and may be welded to the housing 54.

The board 50 has an elongated shape. The LED chips 53 are mounted and arranged on a front surface as a first surface of the board 50. An electric component such as the FFC connector 57 is mounted on a back surface as a second surface of the board 50. The board 50 adheres at a plurality of positions in a longitudinal direction by a third adhesive 59a or the like described below in a state of being separated from the housing 54. The board 50 is provided with a wiring (not illustrated) for supplying a signal to the LED chip 53. Here, the longitudinal direction of the board 50 is the same as the axial direction of the photosensitive drum 2 and the front-rear direction. A lateral direction of the board 50 is a direction orthogonal to the longitudinal direction of the board 50, and is the same direction as the left-right direction.

The lens array 52 has an elongated shape and condenses light emitted from LEDs 51 of the LED chip 53 described below on the surface of the photosensitive drum 2. The lens array 52 includes lenses 521 arranged in two rows in an arrangement direction of the LEDs 51. The lens array 52 is a lens assembly including the plurality of lenses 521.

A position of the lens array 52 is adjusted such that a distance between a light emitting surface of the LED 51 and a light incident surface 52b of the lens 521 is substantially equal to a distance between a light emission surface 52a of the lens 521 and the surface of the photosensitive drum 2. The lens array 52 adheres at a plurality of positions in the longitudinal direction of the board 50 and the lens array 52 by a sixth adhesive 59b described below or the like in a state of being separated from the housing 54. Here, the longitudinal direction of the lens array 52 is the same as the longitudinal direction of the exposure head 4.

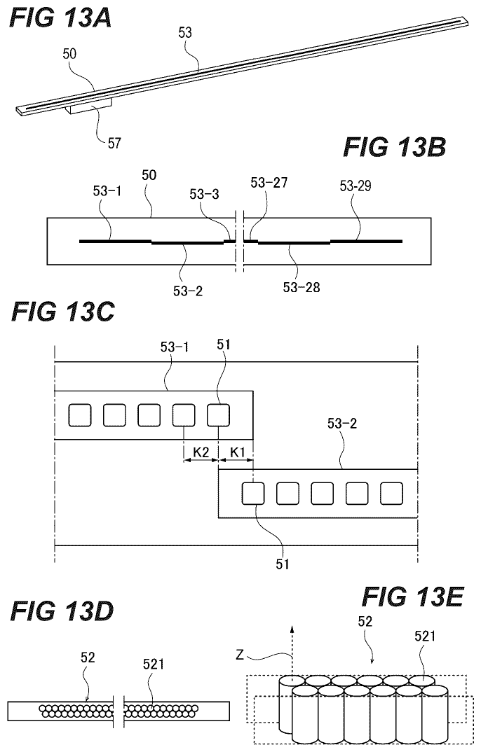

The lens 521 is a cylindrical rod lens made of glass, and has the light incident surface 52b on which the light emitted from the LED 51 is incident and the light emission surface 52a from which the light incident from the light incident surface 52b is emitted (see FIG. 10), and condenses the incident light on the surface of the photosensitive drum 2. The material of the lens 521 is not limited to glass, and may be plastic. The shape of the lens 521 is not limited to the cylindrical shape, and may be, for example, a polygonal prism such as a hexagonal prism. As illustrated in FIG. 13E, the lens 521 in one of the two rows are in contact with two adjacent lenses 521 in an arrangement direction of the lenses 521 in the other one of the two rows.

The LED chip 53 serving as a light emitting chip includes the LEDs 51 serving as a plurality of light emitting portions that emits light, and is mounted on the front surface of the board 50. A detailed configuration of the LED chip 53 is described below.

The housing 54 is a metal member formed by bending a plate material such as a plated galvanized steel plate or cold-rolled steel plate so as to have a U-shaped cross section by press working. The housing 54 holds the board 50 and the lens array 52. A detailed configuration of the housing 54 and a configuration of an adhesion and sealing mechanism between the housing 54, and the board 50 and the lens array 52 are described below.

The housing support member 55 is a member having a longitudinal shape and extending in the axial direction of the photosensitive drum 2, and supports the housing 54 in the longitudinal direction. The housing support member 55 is formed to have a U-shaped cross section. A detailed configuration of the housing support member 55 is described below.

The FFC connector 57 serving as a connector is mounted on the back surface of the board 50 that is opposite to the front surface such that a longitudinal direction of the FFC connector 57 is along the longitudinal direction of the board 50. The FFC connector 57 is provided on one end side (front side) of the board 50. One end of a flexible flat cable (FFC) 58 in a longitudinal direction is connected to the FFC connector 57.

In the above configuration, the other end of the flexible flat cable 58 connected to the FFC connector 57 in the longitudinal direction is connected to a connector and a controller mounted on a board (not illustrated) provided in the image forming apparatus 100. The LED chip 53 is driven by a control signal (drive signal) input from the controller and the connector of the image forming apparatus 100 via a cable, the FFC connector 57, and the wiring of the board 50.

In addition, the exposure head 4 is movable in the optical axis direction substantially along an optical axis Z of the lens 521 (see FIG. 13E) by a retraction mechanism for the rotating arm 65 and the elevating duct 69 described below. The optical axis Z of the lens 521 here means a line connecting the center of the light emission surface of the lens 521 and a focal point of the lens 521. In addition, since the lens array 52 is a lens assembly including the plurality of lenses 521, the optical axis Z is an optical axis of an arbitrary lens 521 among the plurality of lenses 521.

Strictly speaking, the plurality of lenses 521 may be slightly inclined with respect to each other. Such inclination is caused by a tolerance during assembly. However, it is assumed that the optical axes Z of the plurality of lenses 521 are directed in the same direction without considering a deviation in the tolerance.

In the exposure head 4, the LED 51, which is a semiconductor LED, is used as a light source, but the present invention is not limited thereto, and an organic light emitting diode (OLED) may be used as the light source. The OLED is also called organic electro-luminescence (EL), and is a current-driven light emitting element. The OLEDs are arranged in a line along a main scanning direction that is the axial direction of the photosensitive drum 2 on a thin film transistor (TFT) board, for example, and are electrically connected in parallel by a power supply wiring provided in the main scanning direction.

### Configuration of LED Chip

The configuration of the LED chip 53 of the exposure head 4 according to the embodiment of the present invention will be described in detail with reference to FIGS. 13A to 13E.

The LED chip 53 includes the plurality of LEDs 51, and the plurality of LED chips 53 is arranged on one surface of the board 50. Here, the number of LED chips 53 is 29. The LED 51 can be the organic electro-luminescence (EL) in order to save power.

516 LEDs 51 are arranged in a line on each of the LED chips 53-1 to 53-29 in a longitudinal direction. In the longitudinal direction of the LED chip 53, a center-to-center distance k2 between adjacent LEDs 51 corresponds to a resolution of the image forming apparatus 100. The longitudinal direction of the LED chip 53 is the same as the longitudinal direction of the exposure head 4.

For example, in a case where the resolution of the image forming apparatus 100 is 1200 dpi, the center-to-center distance k2 is 21.16 μm, and an exposure range of the exposure head 4 is about 314 mm. In this case, a photosensitive layer of the photosensitive drum 2 is formed to have a width of 314 mm or more. Further, since a length of a long side of an A4-size recording sheet S and a length of a short side of an A3-size recording sheet S are 297 mm, the exposure head 4 has the exposure range in which an image can be formed on the A4-size recording sheet S and the A3-size recording sheet S.

The LED chips 53-1 to 53-29 are arranged in two rows in a rotational axis direction of the photosensitive drum 2. Specifically, the odd-numbered LED chips 53-1, 53-3, . . . , and 53-29 counted from a left side are mounted on the board 50 in a row in the longitudinal direction. Further, the even-numbered LED chips 53-2, 53-4, . . . , and 53-28 counted from the left side are mounted on the board 50 in a row in the longitudinal

The LED chips 53-2, 53-4, . . . , and 53-28 are arranged in a different row from that of the LED chips 53-1, 53-3, . . . , and 53-29. A center-to-center distance k1 between an LED 51 at one end of the odd-numbered LED chips 53-1, . . . , and 53-29 in an arrangement direction and an LED 51 at the other end of the even-numbered LED chips 53-2, . . . , and 53-28 in an arrangement direction is the same as the center-to-center distance k2.

### Configuration of Housing

The configuration of the housing 54 of the exposure head 4 according to the embodiment of the present invention will be described in detail with reference to FIGS. 10 to 18.

The housing 54 has a first opening portion 54a, a second opening portion 54b, a flat surface portion 54U, an extending portion 54R, and an extending portion 54L.

The first opening portion 54a is provided in the flat surface portion 54U. The lens array 52 is inserted through the first opening portion 54a.

The second opening portion 54b is provided at a position facing the flat surface portion 54U and is provided between the extending portion 54L and the extending portion 54R.

The flat surface portion 54U faces the photosensitive drum 2 in a direction of the optical axis Z of the lens 521 of the lens array 52. The flat surface portion 54U is not limited to a flat surface, and may be a slightly curved surface.

The extending portion 54R extends in a direction away from the photosensitive drum 2 from one end side of the flat surface portion 54U in a lateral direction.

The extending portion 54L extends in a direction away from the photosensitive drum 2 from the other end side of the flat surface portion 54U in the lateral direction. The extending portion 54L faces the extending portion 54R.

### Configuration of Housing Support Member

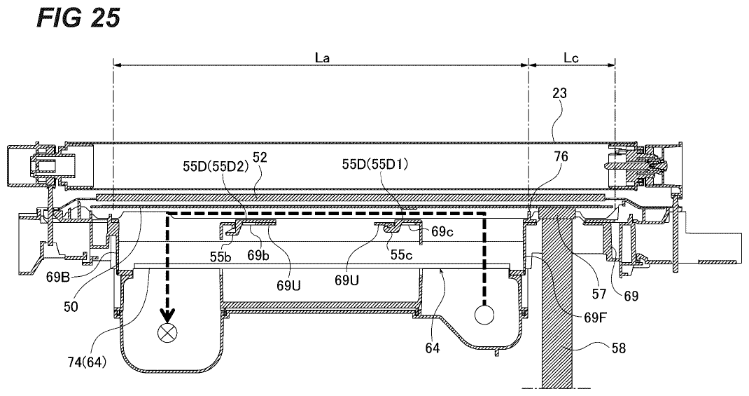

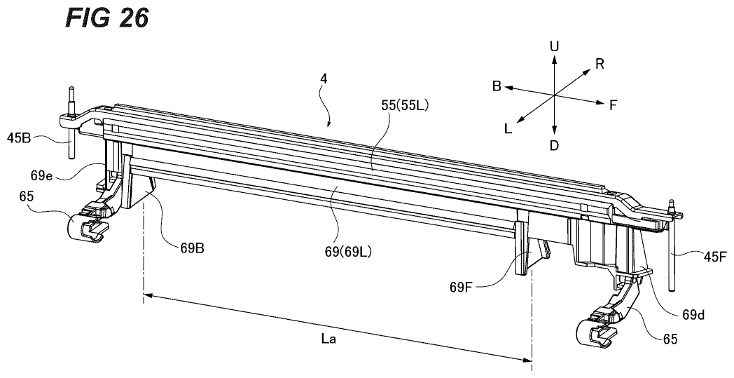

The configuration of the housing support member 55 of the exposure head 4 according to the embodiment of the present invention will be described in detail with reference to FIGS. 10, 12, and 21 to 26.

The housing support member 55 has a left side wall 55L, a right side wall 55R, a bottom surface portion 55D, opening portions 55a, an engagement projection 55b, and an engagement projection 55c.

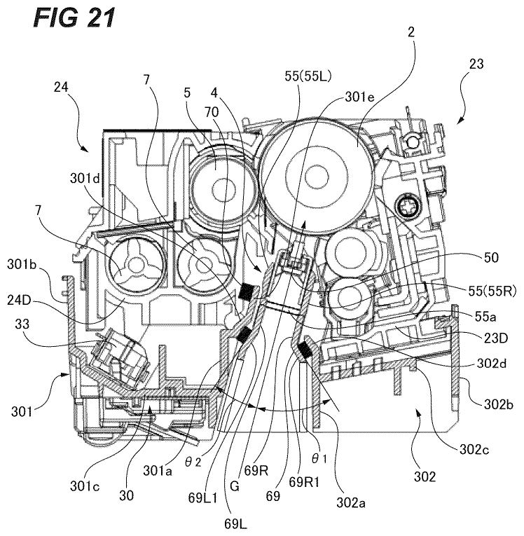

The left side wall 55L is provided between the housing 54 and the developing unit 24 in a longitudinal direction of the housing support member 55 so as to separate the housing 54 and the developing unit 24 from each other at one end portion of the bottom surface portion 55D in a lateral direction (see FIG. 21).

The right side wall 55R faces the left side wall 55L. The right side wall 55R is provided between the housing 54 and the drum unit 23 in the longitudinal direction of the housing support member 55 so as to separate the housing 54 and the drum unit 23 from each other on the other end side of the bottom surface portion 55D in the lateral direction (see FIG. 21).

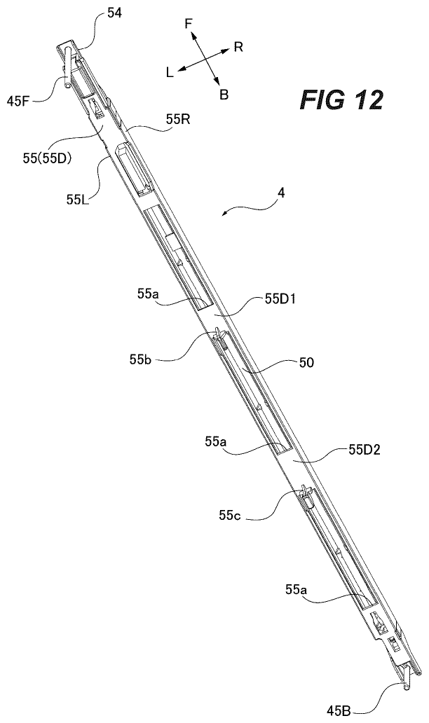

The bottom surface portion 55D connects the left side wall 55L and the right side wall 55R, and faces the flat surface portion 54U of the housing 54 (see FIG. 10). The bottom surface portion 55D faces the back surface of the board 50 that is opposite to the front surface on which the LED 51 is mounted. The bottom surface portion 55D faces an upper surface portion 69U of the elevating duct 69. The bottom surface portion 55D includes a first bottom surface portion 55D1 and a second bottom surface portion 55D2 (see FIG. 12).

The first bottom surface portion 55D1 is provided between the front-most opening portion 55a and the central opening portion 55a between the front-most opening portion 55a and the rear-most opening portion 55a.

The second bottom surface portion 55D2 is provided between the rear-most opening portion 55a and the central opening portion 55a.

The plurality of opening portions 55a is provided in the bottom surface portion 55D in the longitudinal direction of the housing support member 55.

The engagement projection 55b can be elastically deformed, and is provided on the first bottom surface portion 55D1. The engagement projection 55b protrudes toward the elevating duct 69 and has a substantially L shape in which a tip of the engagement projection 55b in a protruding direction is further bent in the axial direction of the photosensitive drum 2 that is orthogonal to the protruding direction and extends rearward. The engagement projection 55b is engaged with the elevating duct 69 by snap-fitting. The engagement projection 55b includes a recess 55f recessed toward a tip portion in an extending direction.

The engagement projection 55c can be elastically deformed, and is provided on the second bottom surface portion 55D2. The engagement projection 55c protrudes toward the elevating duct 69 and has a substantially L shape in which a tip of the engagement projection 55c in a protruding direction is further bent in the axial direction of the photosensitive drum 2 that is orthogonal to the protruding direction and extends rearward. The engagement projection 55c is engaged with the elevating duct 69 by snap-fitting.

### Configuration of Elevating Duct

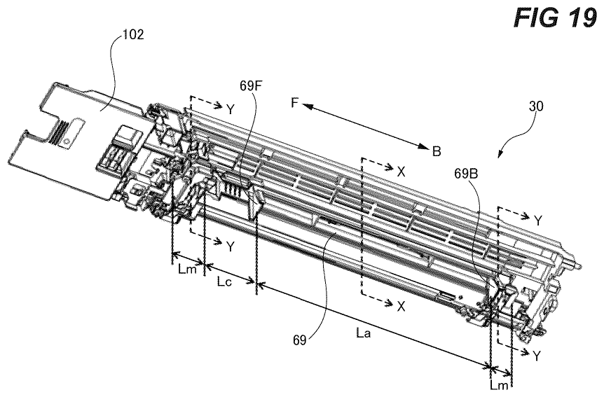

The configuration of the elevating duct 69 of the image forming apparatus 100 according to the embodiment of the present invention will be described in detail with reference to FIGS. 19 to 26 and 33.

The elevating duct 69 has opening portions 69a, the upper surface portion 69U, a left duct wall 69L, a right duct wall 69R, a front duct wall 69F, a rear duct wall 69B, an engagement hole 69b, an engagement hole 69c, a first engagement portion 69d, a second engagement portion 69e, and a protrusion 69f.

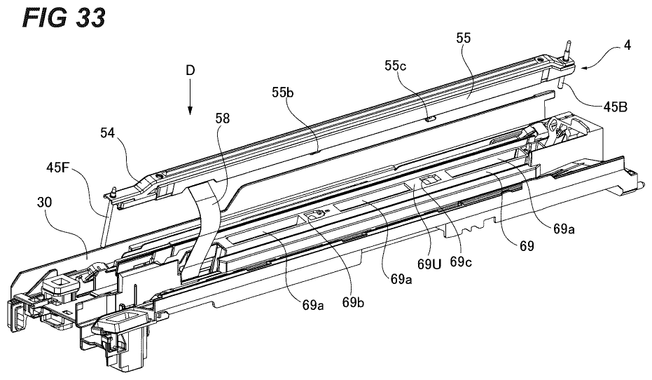

The plurality of opening portions 69a is provided in the upper surface portion 69U in a longitudinal direction of the elevating duct 69 which is the axial direction of the photosensitive drum 2 (see FIG. 33). The opening portions 69a are provided at positions facing the plurality of opening portions 55a provided in the bottom surface portion 55D of the housing support member 55, and communicate with the opening portions 55a.

The upper surface portion 69U faces the bottom surface portion 55D of the housing support member 55 and detachably supports the exposure head 4. The upper surface portion 69U is surrounded by the left duct wall 69L, the right duct wall 69R, the front duct wall 69F, and the rear duct wall 69B.

The left duct wall 69L is provided at one end portion of the upper surface portion 69U in a lateral direction and is provided at a position facing the developing unit 24. The left duct wall 69L is provided in the longitudinal direction of the elevating duct 69, and connects the front duct wall 69F and the rear duct wall 69B. The left duct wall 69L has a first inclined surface 69L1 inclined in a direction away from the right duct wall 69R in a movement direction of the elevating duct 69 from the exposure position to the retracted position. The first inclined surface 69L1 is provided at a position facing the developing support member 301 on the left duct wall 69L, and is inclined at an angle 02 with respect to the movement direction (a direction of an arrow G illustrated in FIG. 21) of the elevating duct 69 from the retracted position to the exposure position.

The right duct wall 69R is provided at the other end of the upper surface portion 69U in the lateral direction and faces the left duct wall 69L. The right duct wall 69R is provided at a position facing the drum unit 23, is provided in the longitudinal direction of the elevating duct 69, and connects the front duct wall 69F and the rear duct wall 69B. The right duct wall 69R has a second inclined surface 69R1 inclined in a direction away from the left duct wall 69L in the movement direction of the elevating duct 69 from the exposure position to the retracted position.

The second inclined surface 69R1 is provided at a position facing the drum support member 302 on the right duct wall 69R, and is inclined at an angle θ1 with respect to the movement direction (the direction of the arrow G illustrated in FIG. 21) of the elevating duct 69 from the retracted position to the exposure position.

The front duct wall 69F is provided at one end portion of the upper surface portion 69U in a longitudinal direction. The front duct wall 69F protrudes toward a tip side from the left duct wall 69L and the right duct wall 69R in the movement direction of the elevating duct 69 from the exposure position to the retracted position.

The rear duct wall 69B is provided at the other end portion of the upper surface portion 69U in the longitudinal direction. The rear duct wall 69B faces the front duct wall 69F. The rear duct wall 69B protrudes toward a tip side from the left duct wall 69L and the right duct wall 69R in the movement direction of the elevating duct 69 from the exposure position to the retracted position.

The engagement hole 69b is provided in the upper surface portion 69U between an opening portion 69a provided on one end side (front side) of the upper surface portion 69U in the longitudinal direction and an opening portion 69a adjacent to the opening portion 69a in the longitudinal direction of the upper surface portion 69U. The engagement hole 69b is engaged with the engagement projection 55b of the housing support member 55 by snap-fitting.

The engagement hole 69c is provided in the upper surface portion 69U between an opening portion 69a provided on the other end side (rear side) in the longitudinal direction and an opening portion 69a adjacent to the opening portion 69a. The engagement hole 69c is engaged with the engagement projection 55c of the housing support member 55 by snap-fitting.

The first engagement portion 69d is provided on one end side of the elevating duct 69 in the longitudinal direction, and can be engaged with the rotating arm 65. The first engagement portion 69d is provided outside the front duct wall 69F in the longitudinal direction. The first engagement portion 69d is provided further outside the FFC connector 57 positioned outside the front duct wall 69F in the longitudinal

The second engagement portion 69e is provided on the other end side of the elevating duct 69 in the longitudinal direction, and can be engaged with the rotating arm 65. The second engagement portion 69e is provided outside the rear duct wall 69B in the longitudinal direction.

The protrusion 69f is provided at a position corresponding to a position of the recess 55f when the exposure head 4 moves to a sliding operation completion position (mounting completion position) with respect to the elevating duct 69. The protrusion 69f is engaged with the recess 55f when the exposure head 4 is positioned at the sliding operation completion position.

The elevating duct 69 having the above configuration has a shape in which the upper surface portion 69U, the left duct wall 69L, the right duct wall 69R, the front duct wall 69F, and the rear duct wall 69B are integrally formed, and the openings are provided on the upper and lower sides of the elevating duct 69.

Further, the elevating duct 69 is formed in a hollow shape having no opening at positions facing the developing unit 24 and the drum unit 23 and having openings on upper and lower sides.

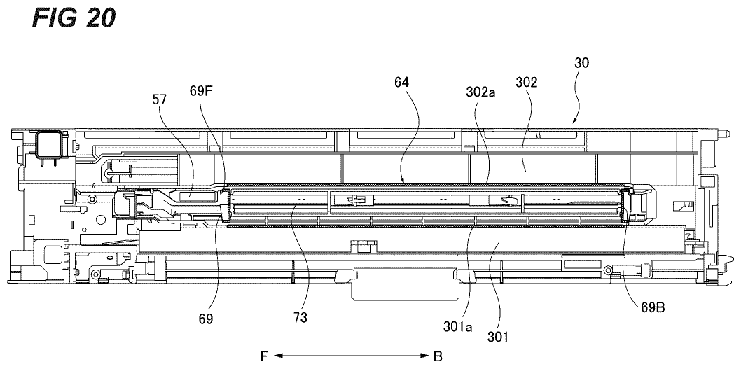

The front duct wall 69F and the rear duct wall 69B of the elevating duct 69 form the opening portion 64 together with a developing guide portion 301a of the developing support member 301 and a drum guide portion 302a of the drum support member 302 (see FIG. 20). The elevating duct 69 forms a duct (closed space) for circulating air from the duct unit (not illustrated) to the back surface of the board 50 through the opening portion 64 and the opening portion 69a and does not allow the air to leak to the adjacent developing unit 24 and drum unit 23. As a result, scattering of the toner inside the apparatus body 100a can be reduced.

Further, the elevating duct 69 is movably disposed between the first developing guide portion 301a and the first drum guide portion 302a of the cartridge tray 30 described below.

A region Lm in FIG. 19 where the first engagement portion 69d is provided is provided outside a duct region La in FIG. 19 where the opening portion 69a is surrounded by the duct walls including the left duct wall 69L, the right duct wall 69R, the front duct wall 69F, and the rear duct wall 69B. A region Lm in FIG. 20 where the second engagement portion 69e is provided is provided outside the duct region La. That is, the duct region La is provided between the region Lm in FIG. 19 where the first engagement portion 69d is provided and the region Lm in FIG. 20 where the second engagement portion 69e is provided.

A region Lc in FIG. 19 where the FFC connector 57 is provided is provided outside the duct region La in FIG. 19 forming the duct in which the opening portion 69a is surrounded by the duct walls, and is provided between the duct region La and the region Lm in FIG. 19 where the first engagement portion 69d is provided. The duct region La includes most of the board 50 on which the LED 51 is mounted. Therefore, the exposure head 4 can be sufficiently cooled by blowing the air to the duct region La. The region Lc is a mounting portion of the FFC connector 57 of a signal line that transmits the drive signal to the board 50 on which the LED 51 is mounted. The region Lc is not provided with an opening for forming the duct, and is configured to enable necessary and sufficient cooling in the duct region La as described above.

The air taken in from the outside of the image forming apparatus 100 by the duct unit (not illustrated) is blown onto the back surface of the board 50 from the opening portion 55a of the housing support member 55 through the elevating duct 69. The air blown from the opening portion 55a of the housing support member 55 to the back surface of the board 50 is exhausted to the outside of the image forming apparatus 100 by the duct unit through the elevating duct 69.

### Configuration of Cartridge Tray

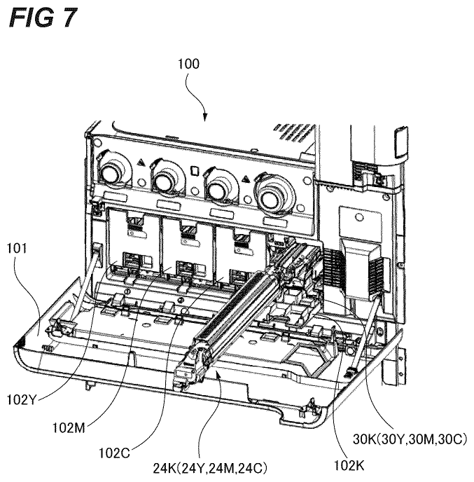

The configuration of the cartridge tray 30 of the image forming apparatus 100 according to the embodiment of the present invention will be described in detail with reference to FIGS. 7 to 9, 19 to 24, and 40.

The cartridge tray 30 includes a developing stay 31, the conductive member 251, the developing support member 301, and the drum support member 302.

The developing stay 31 is provided on a developing bottom surface portion 301c of the developing support member 301 so as to be movable in the axial direction of the photosensitive drum 2. The developing stay 31 has an elongated shape (longitudinal shape) extending in the axial direction of the photosensitive drum 2. A detailed configuration of the developing stay 31 is described below.

The conductive member 251 is a metallic thin plate, and is elastically deformed when coming into contact with the positioning pin 45F and the positioning pin 45B of the exposure head 4, so that sufficient contact pressure can be obtained for the positioning pin 45F and the positioning pin 45B (see FIG. 40). The conductive member 251 is electrically connected to a frame body sheet metal of the image forming apparatus 100 via a circuit board on which a harness (not illustrated), a resistor element (not illustrated) for noise removal, and a capacitor (not illustrated) are mounted.

The developing support member 301 is a member having a longitudinal shape extending in the axial direction of the photosensitive drum 2, and supports the developing unit 24. The rotating arm 65 is rotatably provided on the developing support member 301. The developing support member 301 forms a duct whose upper surface portion forms a closed space together with a bottom surface of the developing unit 24.

The developing support member 301 includes the first developing guide portion 301a, a second developing guide portion 301b, and the developing bottom surface portion 301c. The first developing guide portion 301a, the second developing guide portion 301b, and the developing bottom surface portion 301c are integrally formed.

The first developing guide portion 301a is provided on one end side of the developing bottom surface portion 301c in a lateral direction of the cartridge tray 30, and is provided between the elevating duct 69 and the developing unit 24 to separate the elevating duct 69 and the developing unit 24 from each other. The first developing guide portion 301a guides movement of the developing unit 24 in the axial direction of the photosensitive drum 2 when the developing unit 24 is inserted and removed from the front side of the apparatus body 100a in the axial direction of the photosensitive drum 2. The first developing guide portion 301a includes a facing portion 301d and a partition wall portion 301e.

The facing portion 301d faces the first inclined surface 69L1 of the elevating duct 69 and is inclined similarly to the first inclined surface 69L1.

The partition wall portion 301e is provided on a tip side of the facing portion 301d in the movement direction of the elevating duct 69 from the retracted position to the exposure position. The partition wall portion 301e is provided between the exposure head 4 and the developing unit 24 so as to separate the exposure head 4 positioned at the exposure position illustrated in FIG. 21 from the developing unit 24. The partition wall portion 301e is provided at an upper end portion of the first developing guide portion 301a.

The second developing guide portion 301b faces the first developing guide portion 301a. The second developing guide portion 301b is provided on the other end side of the developing bottom surface portion 301c in the lateral direction of the cartridge tray 30. The second developing guide portion 301b guides the movement of the developing unit 24 in the axial direction of the photosensitive drum 2 when the developing unit 24 is inserted and removed from the front side of the apparatus body 100a in the axial direction of the photosensitive drum 2.

The developing bottom surface portion 301c connects the first developing guide portion 301a and the second developing guide portion 301b to each other. The developing bottom surface portion 301c faces a bottom surface portion 24D of the developing unit 24 with a space therebetween, and is provided in a longitudinal direction of the cartridge tray 30.

The drum support member 302 is a member having a longitudinal shape extending in the axial direction of the photosensitive drum 2, and supports the drum unit 23. The drum support member 302 includes the first drum guide portion 302a, a second drum guide portion 302b, and a drum bottom surface portion 302c. The first drum guide portion 302a, the second drum guide portion 302b, and the drum bottom surface portion 302c are integrally formed.

The first drum guide portion 302a is provided on one end side of the drum bottom surface portion 302c in the lateral direction of the cartridge tray 30, and is provided between the elevating duct 69 and the drum unit 23 to separate the elevating duct 69 and the drum unit 23 from each other. The first drum guide portion 302a abuts on the drum unit 23 and guides movement of the drum unit 23 in the axial direction of the photosensitive drum 2 when the drum unit 23 is inserted and removed from the front side of the apparatus body 100a in the axial direction of the photosensitive drum 2. The first drum guide portion 302a includes a facing portion 302d facing the second inclined surface 69R1 of the elevating duct 69. The facing portion 302d is inclined similarly to the second inclined surface 69R1 of the elevating duct 69.

The second drum guide portion 302b is provided on the other end side of the drum bottom surface portion 302c in the lateral direction of the cartridge tray 30, and faces the first drum guide portion 302a. The second drum guide portion 302b abuts on the drum unit 23, and guides the movement of the drum unit 23 in a longitudinal direction when the drum unit 23 is inserted into and removed from the front side of the apparatus body 100a in the longitudinal direction.

The drum bottom surface portion 302c connects the first drum guide portion 302a and the second drum guide portion 302b to each other. The drum bottom surface portion 302c faces a bottom surface portion 23D of the drum unit 23 and is provided in the longitudinal direction of the cartridge tray 30.

In the cartridge tray 30 having the above configuration, the first developing guide portion 301a and the first drum guide portion 302a function as guide members that guide the movement of the elevating duct 69.

Further, the cartridge tray 30 forms a duct having a closed space communicating with the opening portion 55a of the exposure head 4 together with the elevating duct 69 disposed between the first developing guide portion 301a and the first drum guide portion 302a.

### Configuration of Developing Stay

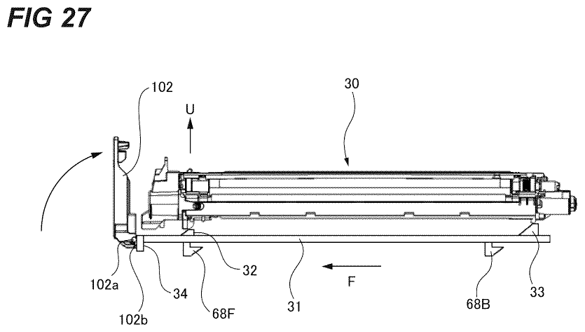

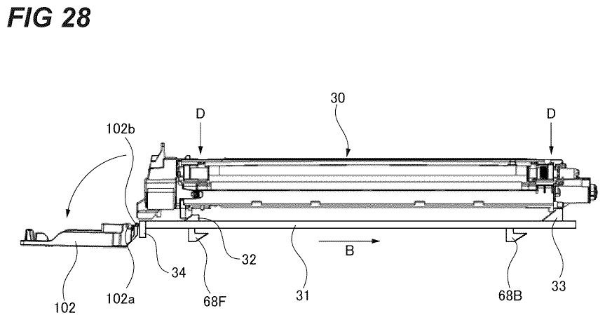

The configuration of the developing stay 31 of the image forming apparatus 100 according to the embodiment of the present invention will be described in detail with reference to FIGS. 27 and 28.

The developing stay 31 includes a developing pressing block 32, a developing pressing block 33, the developing stay link 34, an arm retraction member 68F, and an arm retraction member 68B.

The developing pressing block 32 is provided at a position facing the developing unit 24, and is fixed to one end side (front side) of the developing stay 31 in a longitudinal direction.

The developing pressing block 33 is provided at a position facing the developing unit 24, and is fixed to the other end side (rear side) of the developing stay 31 in the longitudinal direction.

The developing stay link 34 is provided on one end side of the developing stay 31 in the longitudinal direction, and is engaged with the link engagement portion 102b of the inner door 102 axially supported by the cartridge tray 30.

The arm retraction member 68F is provided on one end side of the developing stay 31 in the longitudinal direction, and is provided on a surface of the developing stay 31 that is opposite to a surface on which the developing pressing block 32 is provided. The arm retraction member 68F is slid in the front-rear direction in conjunction with an opening/closing operation of the inner door 102 to rotate the rotating arm 65.

The arm retraction member 68B is provided on the other end side of the developing stay 31 in the longitudinal direction, and is provided on a surface of the developing stay 31 opposite to a surface on which the developing pressing block 33 is provided. The arm retraction member 68B is slid in the front-rear direction in conjunction with the opening/closing operation of the inner door 102 to rotate the rotating arm 65.

### Configuration of Adhesion and Sealing Mechanism between Housing and Board and Lens Array

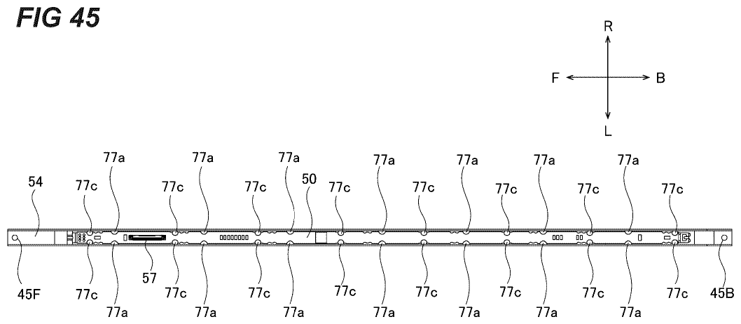

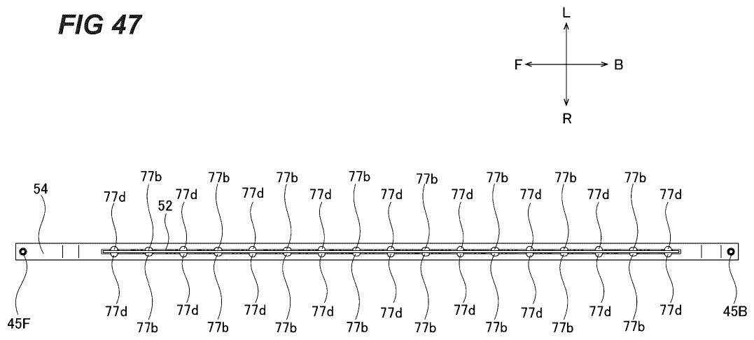

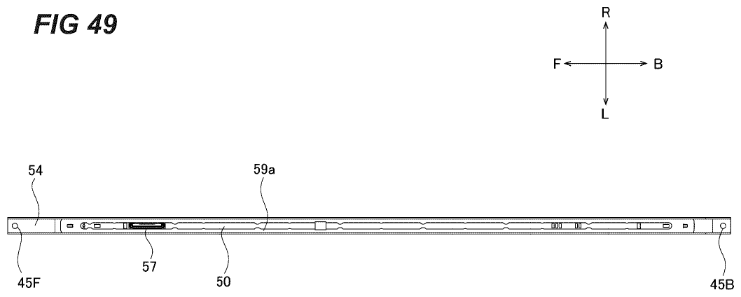

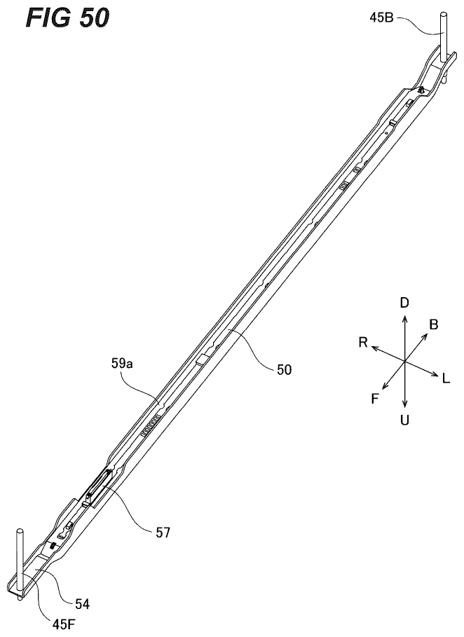

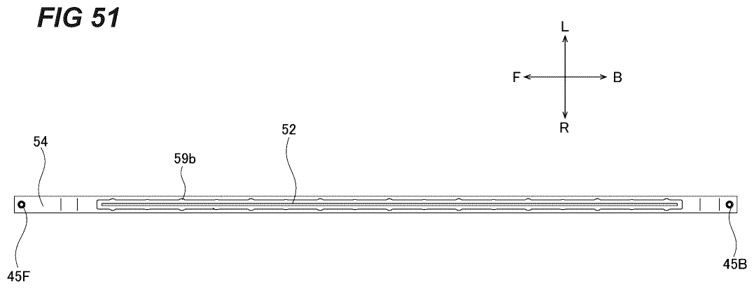

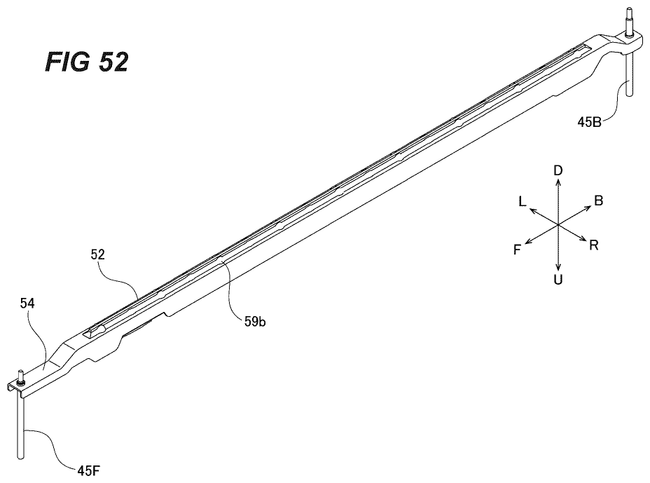

The configuration of the adhesion and sealing mechanism between the housing 54 of the exposure head 4 and the board 50 and the lens array 52 according to the embodiment of the present invention will be described in detail with reference to FIGS. 45 to 52.

In the exposure head 4 according to the present embodiment, temperatures of the housing 54 and the board 50 may increase as the LED 51 emits light. In this case, when thermal expansion coefficients of the housing 54 and the board 50 are different from each other, a difference in dimension between the housing 54 and the board 50 due to heat generation increases, and there is a possibility that adhesion between the housing 54 and the board 50 peels off. In order to reduce the possibility that the adhesion between the housing 54 and the board 50 peels off, it is desirable to firmly make the housing 54 and the board 50 adhere to each other.

In addition, in a case where the board 50 adheres to the housing 54, it is necessary to make the board 50 and the housing 54 adhere to each other at an appropriate position in order to increase optical efficiency to the maximum. Meanwhile, some adhesives capable of achieving strong adhesion require time for curing, and thus, displacement between the housing 54 and the board 50 may occur during a period from application of the adhesive to curing.

In order to solve the above-described problem, in the present embodiment, the adhesion between the housing 54, the board 50, and the lens array 52 is made by the following method.

Both end portions of the board 50 inserted and positioned in the second opening portion 54b of the housing 54 in the lateral direction, and the extending portion 54L and the extending portion 54R of the housing 54 adhere to each other and are temporarily fixed by a second adhesive 77c. As the second adhesive 77c, an acryl-based photocurable resin that has a characteristic of being curable in a short time at room temperature and is cured by UV irradiation is used.

It is desirable that adhesion points of the second adhesives 77c are arranged at positions substantially symmetrical in the lateral direction with respect to the center of the board 50 in the lateral direction and are arranged at substantially equal intervals in the longitudinal direction of the board 50. In addition, the number of adhesion points of the second adhesive 77c in the longitudinal direction is desirably three or more in order to correct warpage of the board 50. Here, a case where the number of adhesion points is eight is exemplified.

In addition, it is desirable that positions where the second adhesive 77c is provided at both end portions of the board 50 in the longitudinal direction are outside an image forming region in order to favorably correct the warpage of the board 50 in the image forming region. The image forming region corresponds to a region where the LED chip 53 is mounted in the longitudinal direction of the exposure head 4. The light emitted from the LED chip 53 does not reach the photosensitive drum 2 outside the image forming region in the longitudinal direction of the exposure head 4, and thus, the electrostatic latent image is not formed on the photosensitive drum 2. In addition, the second adhesive 77c is disposed at a position not overlapping the FFC connector 57 mounted on the board 50 in an up-down direction when viewed from the lateral direction of the board 50.

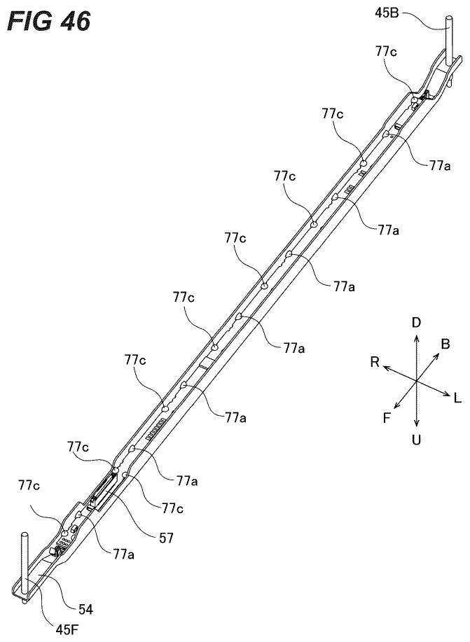

Further, the second adhesive 77c is disposed near one end portion (the other end portion) of the FFC connector 57 in the longitudinal direction (see FIG. 46). The second adhesive 77c is separated from the FFC connector 57.

Further, a side surface of the lens array 52 inserted and positioned in the first opening portion 54a of the housing 54 and the flat surface portion 54U of the housing 54 adhere to each other and are temporarily fixed by a fifth adhesive 77d. As the fifth adhesive 77d, an acryl-based photocurable resin that has a characteristic of being curable in a short time at room temperature and is curable by UV irradiation is used.

It is desirable that adhesion points of the fifth adhesive 77d are arranged at positions substantially symmetrical in a lateral direction with respect to the center of the lens array 52 in the lateral direction and are arranged at substantially equal intervals in the longitudinal direction of the lens array 52. The number of adhesion points of the fifth adhesive 77d in the longitudinal direction of the lens array 52 is desirably three or more in order to correct warpage of the lens array 52. Here, a case where the number of adhesion points is nine is exemplified. In addition, it is desirable that positions where the fifth adhesive 77d is provided at both end portions of the lens array 52 in the longitudinal direction are outside the image forming region in order to favorably correct the warpage of the lens array 52 in the image forming region.

A temperature of the LED chip 53 of the exposure head 4 used in the present embodiment increases with light emission during image formation. The increase in temperature of the LED chip 53 propagates to the entire exposure head 4, and the temperatures of the board 50 and the housing 54 increase. When the temperature of the exposure head 4 increases, dimensions of the respective members of the exposure head 4 change according to a linear expansion coefficient. In particular, in a case where there is a large difference in linear expansion coefficient like a case where the housing 54 is made of metal and the board 50 is made of resin, there is a large difference in dimensional change caused by the increase in temperature between the housing 54 and the board 50. At this time, an adhesive force of the adhesive for making the housing 54 and the board 50 adhere to each other cannot withstand the dimensional difference, and there is a possibility that the housing 54 and the board 50 are peeled off. For this reason, a strong adhesive force capable of withstanding the dimensional difference between the members caused by thermal expansion is required for the housing 54 and the board 50.

In addition, the adhesive for making the housing 54 and the board 50 adhere to each other may also thermally expand with the increase in temperature depending on properties thereof.

Here, the linear expansion coefficient of the acryl-based photocurable resin used for the second adhesive 77c and the fifth adhesive 77d is generally several 100 ppm/° C. Therefore, heat generated in the LED chip 53 may propagate to the second adhesive 77c and the fifth adhesive 77d, and thermal expansion may occur.

In addition, application amounts of the second adhesive 77c and the fifth adhesive 77d are not uniform and vary depending on regions to which the second adhesive 77c and the fifth adhesive 77d are applied. Therefore, there is a difference in dimension between the second adhesive 77c and the fifth adhesive 77d after the temperature increases according to the application amounts. As a result, a position of the board with respect to the housing 54 changes, and an optical axis of the LED chip 53 is shifted, and thus, there is a possibility that a predetermined quantity of light does not reach the photosensitive drum 2. A curing rate of the fifth adhesive 77d corresponds to a fourth rate, and a cured elastic modulus of the fifth adhesive 77d corresponds to a fourth elastic modulus.

Therefore, the housing 54, the board 50, and the lens array 52 are temporarily fixed with the acryl-based photocurable resin, and then are permanently fixed with a thermosetting resin having characteristics of a higher elastic modulus and a lower linear expansion coefficient.

Specifically, in the board 50 and the housing 54 that are temporarily fixed, both end portions of a lower surface of the board 50 in the lateral direction, and the extending portion 54L and the extending portion 54R of the housing 54 adhere to each other and are permanently fixed by a first adhesive 77a. As the first adhesive 77a, an epoxy-based thermosetting resin having a cured elastic modulus of several 10 GPa, a glass transition temperature of around 100° C., and a linear expansion coefficient of several 10 ppm/° C. in an actual use environmental temperature range is used. The first adhesive 77a that is the thermosetting resin has a property that curing proceeds when applied with heat after application. Here, the thermosetting resin has an excellent cured elastic modulus as compared with a photocurable adhesive.

The first adhesive 77a used in the present embodiment is cured by being heated in an oven at 100° C. for several hours. In the present embodiment, the board 50 is positioned at a predetermined position with respect to the housing 54 and then fixed using an adhesive. However, in a case where it takes time to make the housing 54 and the board 50 adhere to each other, there is a possibility that the position of the board 50 with respect to the housing 54 deviates from a predetermined value before the adhesive is completely cured.

On the other hand, in the present embodiment, first, the board 50 and the housing 54 adhere to each other using the second adhesive 77c that is the photocurable adhesive excellent in curing rate. After the curing of the photocurable adhesive is completed, the first adhesive 77a that is the thermosetting resin is applied to perform permanent fixing between the board 50 and the housing 54. A rate at which the second adhesive 77c is cured is higher than a rate at which the first adhesive 77a is cured. Therefore, it is possible to reliably determine the position of the board 50 with respect to the housing 54, and it is possible to reduce a possibility that the position of the board 50 with respect to the housing 54 deviates even when it takes time to cure the applied thermosetting resin.

In addition, the cured elastic modulus of the first adhesive 77a is higher than a cured elastic modulus of the second adhesive 77c. As a result, even when thermal expansion occurs due to the increase in temperature, it is possible to reduce a possibility that the position of the board 50 with respect to the housing 54 changes.

The first adhesive 77a is cured by being heated in an oven at 100° C. for several hours. It is desirable that the first adhesive 77a evenly disperses stress generated between the board 50 and the housing 54 in the longitudinal direction of the exposure head 4. Therefore, it is desirable that adhesion points of the first adhesive 77a are arranged at positions substantially symmetrical in the lateral direction with respect to the center of the board 50 in the lateral direction and are arranged at substantially equal intervals in the longitudinal direction of the board 50.

In addition, the number of adhesion points of the first adhesive 77a in the longitudinal direction is desirably three or more in order to permanently correct the warpage of the board 50. Here, a case where the number of adhesion points is seven is exemplified. In addition, the adhesion points of the first adhesive 77a in the longitudinal direction can be positioned between the adhesion points of the second adhesive 77c adjacent to each other in the longitudinal direction. That is, the adhesion points of the second adhesive 77c in the longitudinal direction can be positioned between the adhesion points of the first adhesive 77a adjacent to each other in the longitudinal direction.

Further, the first adhesive 77a is disposed at a position not overlapping the FFC connector 57 mounted on the back surface of the board 50 when viewed from the lateral direction of the board 50, and is disposed near the other end portion (one end portion) of the FFC connector 57 in the longitudinal direction (see FIG. 46). The first adhesive 77a is separated from the FFC connector 57.

In addition, in order to reduce an influence of the second adhesive 77c whose thermal deformation amount is large when the temperature increases, the adhesion points of the first adhesive 77a may be arranged closer to the second adhesive 77c by about several mm rather than being arranged at equal intervals in the longitudinal direction.

The first adhesive 77a is disposed on an inner side of the second adhesive 77c in the longitudinal direction, but is not limited thereto, and the first adhesive 77a may be disposed on an outer side of the second adhesive 77c in the longitudinal direction. A curing rate of the first adhesive 77a corresponds to a first rate, and the cured elastic modulus of the first adhesive 77a corresponds to a first elastic modulus. The curing rate of the second adhesive 77c corresponds to a second rate, and the cured elastic modulus of the second adhesive 77c corresponds to a second elastic modulus.

In the lens array 52 and the housing 54 that are temporarily fixed, the flat surface portion 54U and the side surface of the lens array 52 adhere to each other and are permanently fixed by a fourth adhesive 77b. As the fourth adhesive 77b, an epoxy-based thermosetting resin having a cured elastic modulus of several 10 GPa, a glass transition temperature of around 100° C., and a linear expansion coefficient of several 10 ppm/° C. in an actual use environmental temperature range is used. A curing rate of the fourth adhesive 77b corresponds to a third rate, and a cured elastic modulus of the fourth adhesive 77b corresponds to a third elastic modulus.

It is desirable that adhesion points of the fourth adhesive 77b are arranged at positions substantially symmetrical in the lateral direction with respect to the center of the lens array 52 in the lateral direction and are arranged at substantially equal intervals in the longitudinal direction. The number of adhesion points of the fourth adhesive 77b in the longitudinal direction is desirably three or more in order to permanently correct the warpage of the lens array 52. Here, a case where the number of adhesion points is eight is exemplified. In addition, here, a case where fixing points of the fourth adhesive 77b in the longitudinal direction are positioned between fixing points of the fifth adhesive 77d adjacent to each other in the longitudinal direction is exemplified.

A plurality of adhesion points of fourth adhesive 77b may be arranged at positions between the adhesion points of the fifth adhesive 77d adjacent to each other in the longitudinal direction. In addition, in order to reduce an influence of the fifth adhesive 77d whose thermal deformation amount is large when the temperature increases, the adhesion points of the fourth adhesive 77b are not limited to being arranged at strictly equal intervals in the longitudinal direction, and may be arranged closer to the fifth adhesive 77d. At this time, the adhesion points of the fourth adhesive 77b can be arranged so as to sandwich the fifth adhesive 77d from both sides in the longitudinal direction.

The fourth adhesive 77b is disposed on an inner side of the fifth adhesive 77d in the longitudinal direction, but is not limited thereto, and the fourth adhesive 77b may be disposed on an outer side of the fifth adhesive 77d in the longitudinal direction.

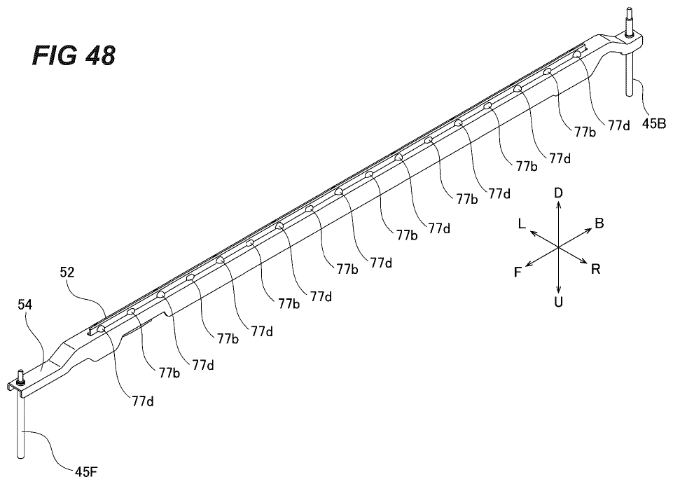

The fourth adhesive 77b is provided at a position included in cross sections of the board 50 and the FFC connector 57 mounted on the board 50 taken along a plane orthogonal to the longitudinal direction (front-rear (FB) direction) (a plane parallel to the left-right (LR) direction and the up-down (DU) direction) (see FIG. 48). That is, the fourth adhesive 77b is provided at a position overlapping the FFC connector 57 mounted on the board 50 in the up-down direction when viewed from the lateral direction of the board 50.

In the board 50 and the housing 54 that are permanently fixed, the extending portion 54L and the extending portion 54R of the housing 54 and both end portions of the lower surface of the board 50 in the lateral direction adhere to each other by the third adhesive 59a and are fixed and sealed. The third adhesive 59a is applied so as to cover the first adhesive 77a and the second adhesive 77c from above. As the third adhesive 59a, a silicon-based moisture-curable resin having a lower viscosity than that of the acryl-based photocurable resin and the epoxy-based thermosetting resin is used.

The third adhesive 59a is not limited to being applied so as to cover the first adhesive 77a and the second adhesive 77c from above, and may be applied at least between the adhesion points of the first adhesive 77a adjacent to each other in the longitudinal direction of the board 50. Alternatively, the third adhesive 59a may be applied so as to cover at least a part of each of the first adhesive 77a and the second adhesive 77c, or may be applied so as to cover a part of any one of the first adhesive 77a and the second adhesive 77c.

In the lens array 52 and the housing 54 that are permanently fixed, the flat surface portion 54U of the housing 54 and the side surface of the lens array 52 adhere to each other by the sixth adhesive 59b and are fixed and sealed. The sixth adhesive 59b is applied so as to cover the fourth adhesive 77b and the fifth adhesive 77d from above. As the sixth adhesive 59b, a silicon-based moisture-curable resin having a lower viscosity than that of the acryl-based photocurable resin and the epoxy-based thermosetting resin is used.

The sixth adhesive 59b is not limited to being applied so as to cover the fourth adhesive 77b and the fifth adhesive 77d from above, and may be applied at least between the adhesion points of the fourth adhesive 77b adjacent to each other in the longitudinal direction of the board 50. Alternatively, the sixth adhesive 59b may be applied so as to cover at least a part of each of the fourth adhesive 77b and the fifth adhesive 77d, or may be applied so as to cover a part of any one of the fourth adhesive 77b and the fifth adhesive 77d.

### Operation of Image Forming Apparatus

An operation of the image forming apparatus 100 according to the embodiment of the present invention will be described in detail with reference to FIGS. 1 to 9.

When image data is input from a reading device, an external host computer (not illustrated), or the like, the image forming apparatus 100 starts the operation and executes the image forming process.

First, the charging roller 3 charges the surface of the photosensitive drum 2.

Next, the exposure head 4 exposes the surface of the photosensitive drum 2 charged by the charging roller 3. As a result, the electrostatic latent image is formed on the photosensitive drum 2.

Next, the developing unit 24 develops the electrostatic latent image formed on the photosensitive drum 2 with the toner. Here, the toner is circularly conveyed at a high speed by the screw 7 inside the developing unit 24. A turning speed of the screw 7 is relatively much higher than turning speeds of the developing sleeve 5 and the photosensitive drum 2. Therefore, the screw 7 can uniformly coat the developing sleeve 5 without unevenness.

Next, the yellow toner image developed on the surface of the photosensitive drum 2Y is transferred to the intermediate transfer belt 9 by the primary transfer roller 6Y. The magenta toner image developed on the surface of the photosensitive drum 2M is transferred to the intermediate transfer belt 9 by the primary transfer roller 6M. The cyan toner image developed on the surface of the photosensitive drum 2C is transferred to the intermediate transfer belt 9 by the primary transfer roller 6C. The black toner image developed on the surface of the photosensitive drum 2K is transferred to the intermediate transfer belt 9 by the primary transfer roller 6K. The toner images are transferred so as to be superimposed on each other on the intermediate transfer belt 9.

The toner images of the respective colors transferred to the intermediate transfer belt 9 are conveyed to the secondary transfer portion T2 by the intermediate transfer belt 9.

The toner images conveyed to the secondary transfer portion T2 are secondarily transferred collectively by the secondary transfer roller 16 to the recording sheet P conveyed from the feeding portion 11 via the registration roller 15.

The recording sheet P to which the toner images have been secondarily transferred is conveyed to the fixing device 19.

The toner images are fixed on the recording sheet P conveyed to the fixing device 19 by heat and pressure in fixing processing in the fixing device 19.

The recording sheet P subjected to the fixing processing by the fixing device 19 is discharged to the discharge tray 21 by the discharge roller 20.

### Replacement Operation for Drum Unit and Developing Unit

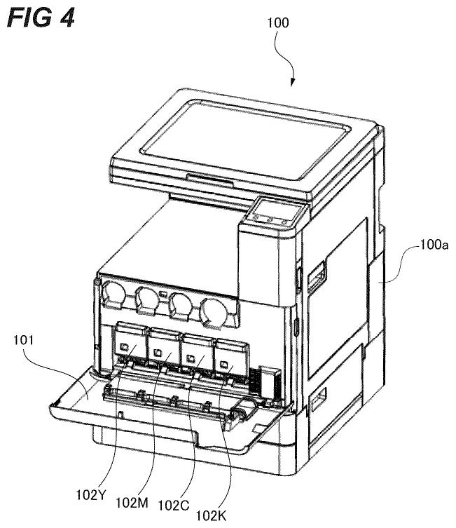

A replacement operation for the drum unit 23 and the developing unit 24 of the image forming apparatus 100 according to the embodiment of the present invention will be described in detail with reference to FIGS. 4 to 9, 21 to 24, 27, and 28.

When replacing the drum unit 23 and the developing unit 24, first, the exposure head 4 and the developing unit 24 are retracted and separated from the photosensitive drum 2. At this time, the exposure head 4 and the developing unit 24 are retracted from the photosensitive drum 2 by the retraction mechanisms such as the developing stay 31, the rotating arm 65, and the elevating duct 69.

Each of the drum unit 23 and the developing unit 24 is inserted and removed from the front side of the image forming apparatus 100, and is mounted at a predetermined position (mounting position) on the apparatus body 100a.

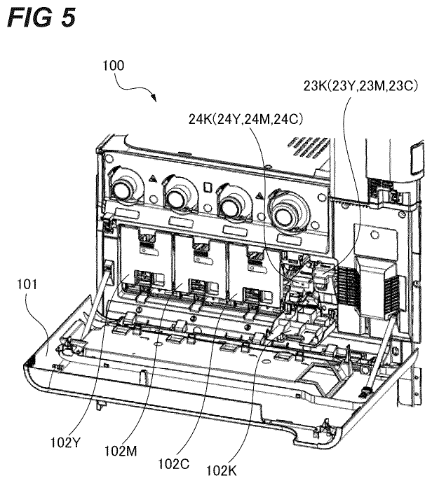

Specifically, in replacement work for the drum unit 23 and the developing unit 24 by the operator, the front cover 101 is opened as illustrated in FIG. 4, and then the inner door 102 is opened as illustrated in FIG. 5. At this time, the link engagement portion 102b of the inner door 102 rotates around the rotation shaft 102a according to the turning of the inner door 102 and moves on a locus of a circle whose radius is a distance between the rotation shaft 102a and the link engagement portion 102b.

As a result, the developing stay link 34 engaged with the link engagement portion 102b is slid rearward along the arrow B. Further, the developing pressing block 32 and the developing pressing block 33 are also slid rearward along the arrow B.

The developing pressing block 32 and the developing pressing block 33 are slid rearward in the direction of the arrow B in FIG. 28 to move from positions where the developing unit 24 is held to positions where the holding of developing unit 24 is released. In addition, the developing stay 31 is disengaged from the rotating arm 65.

When the developing pressing block 32 and the developing pressing block 33 move to the positions where the holding of developing unit 24 is released, the developing unit 24 moves in the downward direction that is a direction of an arrow D in FIG. 28 along inclined surfaces of the developing pressing block 32 and the developing pressing block 33 by its own weight. As a result, the developing sleeve 5 of the developing unit 24 moves in a direction away from the photosensitive drum 2 of the drum unit 23 and is separated from the photosensitive drum 2.

Then, after taking out the drum unit 23 or the developing unit 24 of the apparatus body 100a, a new drum unit 23 or developing unit 24 is inserted into the apparatus body 100a, and the inner door 102 and the front cover 101 are closed, whereby the replacement work is completed.

As illustrated in FIG. 27, the developing stay 31 is slid in a direction of an arrow F that is the forward direction in conjunction with an operation of closing the inner door 102. At this time, the developing unit 24 moves in a direction of an arrow U that is the upward direction along the inclined surfaces of the developing pressing block 32 and the developing pressing block 33 of the developing stay 31. In addition, the developing stay 31 is engaged with the rotating arm 65.

As a result, the developing sleeve 5 of the developing unit 24 moves in a direction approaching the photosensitive drum 2 of the drum unit 23.

In this manner, the developing stay 31 is slid in the direction of the arrow B or the direction of the arrow F in conjunction with the opening/closing operation of the inner door 102. In addition, the developing unit 24 is retracted from the photosensitive drum 2 or approaches the photosensitive drum 2 according to a sliding operation of the developing stay 31.

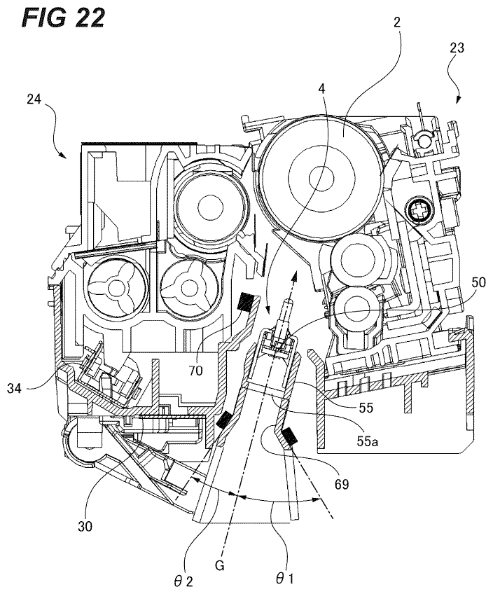

The developing stay 31 is slid in the front-rear direction to move the developing unit 24 between a developing position illustrated in FIG. 21 where the developing sleeve 5 is approaches the photosensitive drum 2 and a separated position illustrated in FIG. 22 where the developing sleeve 5 is separated from the photosensitive drum 2.

### Mounting Operation for Exposure Head

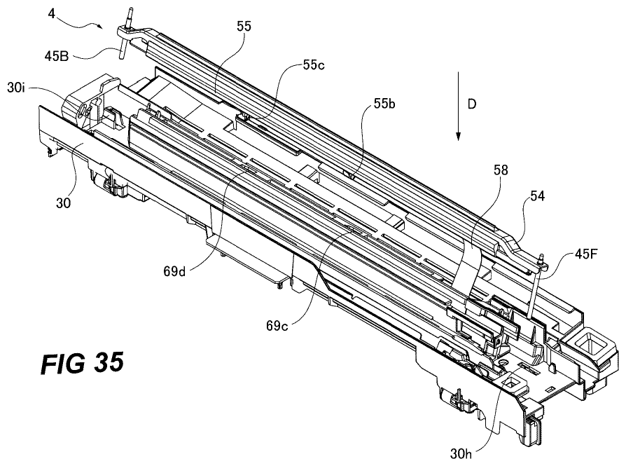

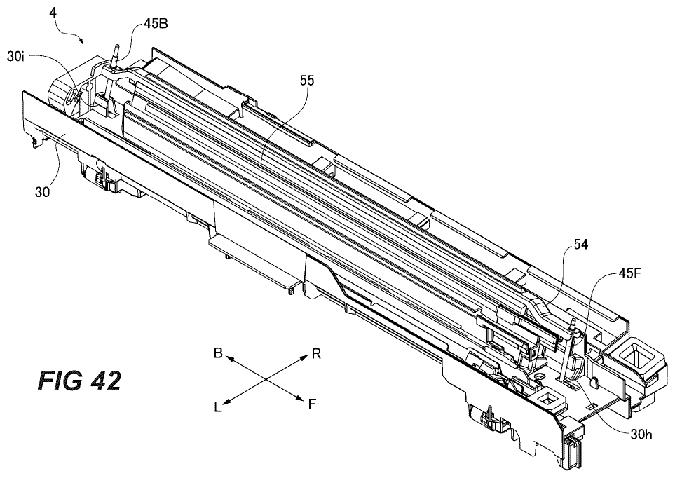

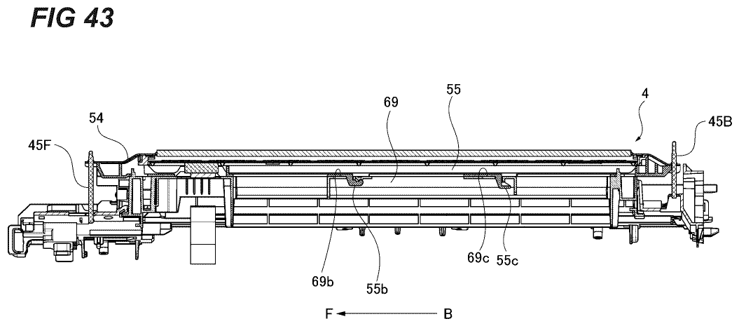

A mounting operation for the exposure head 4 according to the embodiment of the present invention will be described in detail with reference to FIGS. 33 to 35, 38, and 41 to 43.

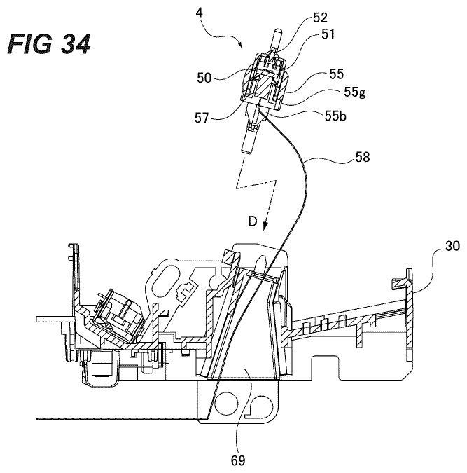

As illustrated in FIG. 34, the mounting operation for the exposure head 4 is performed in a state in which the drum unit 23 and the developing unit 24 are removed from the image forming apparatus 100. In addition, the exposure head 4 is configured to be manually movable from the retracted position to the exposure position in a state in which the photosensitive drum 2 is removed. Therefore, the mounting operation for the exposure head 4 is performed in a state in which the exposure head 4 is manually moved to the exposure position. Furthermore, as illustrated in FIG. 34, the mounting operation for the exposure head 4 is performed in a state in which the FFC 58 connected to the apparatus body 100a is connected to the FFC connector 57 of the exposure head 4 in advance.

First, the housing support member 55 and the elevating duct 69 are integrated with each other by engaging the engagement projections 55b and 55c of the housing support member 55 with the engagement holes 69b and 69c of the elevating duct 69.

Specifically, as the exposure head 4 is moved in the direction of the arrow D in FIG. 23 with respect to the elevating duct 69, the engagement projection 55b and the engagement projection 55c of the exposure head 4 are dropped into the engagement hole 69b and the engagement hole 69c of the elevating duct 69. At the same time, a lower end of the positioning pin 45F of the exposure head 4 is dropped into the auxiliary fitting portion 30h of the cartridge tray 30 with a gap.

Next, as illustrated in FIG. 38, the exposure head 4 is slid in the direction of the arrow B with respect to the elevating duct 69, and the engagement projection 55b and the engagement projection 55c are engaged with the engagement hole 69b and the engagement hole 69c.

Specifically, immediately before completion of the sliding operation of the exposure head 4, the tip of the engagement projection 55b interferes with the protrusion 69f and is elastically deformed. As a result, a sliding operation force of the exposure head 4 temporarily increases as compared with an operation force immediately before the interference. Thereafter, the recess 55f of the engagement projection 55b reaches the protrusion 69f, and the recess 55f and the protrusion 69f are engaged with each other. As a result, the sliding operation force of the exposure head 4 decreases. A clicking sensation can be obtained by the rapid increase and decrease in the sliding operation force of the exposure head 4, and the operator can grasp that the sliding operation of the exposure head 4 is completed by the clicking sensation.

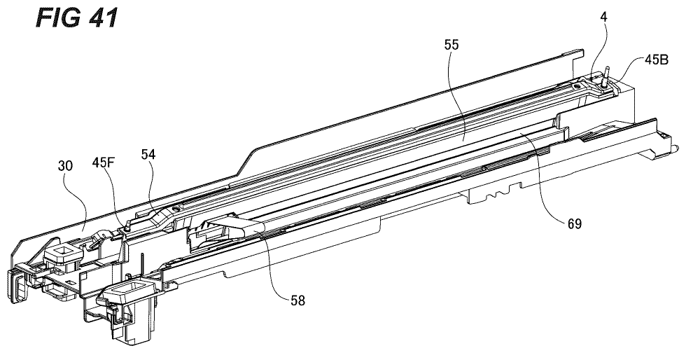

As a result, the exposure head 4 is mounted on the elevating duct 69 and integrated with the elevating duct 69 as illustrated in FIGS. 41 to 43. In the mounting operation for the exposure head 4, easy mounting of the exposure head 4 can be achieved with an inexpensive configuration.

Further, the positioning pin 45F can be electrically connected to the conductive member 251 by the sliding operation of the exposure head 4, and the exposure head 4 can be connected to the ground. As a result, the exposure head 4 can easily be connected to the ground or the like only by the sliding operation, so that occurrence of radiation noise such as electromagnetic waves can be suppressed, and stable grounding characteristics can be obtained.

### Positioning Method for Exposure Head

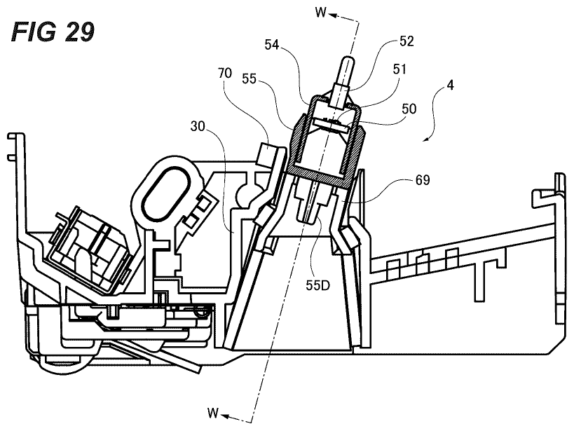

A positioning method for the exposure head 4 according to the embodiment of the present invention will be described in detail with reference to FIGS. 29 to 32.

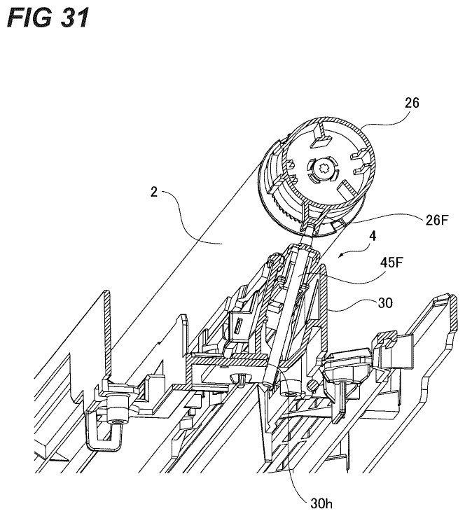

In FIG. 29, the drum unit 23 and the developing unit 24 are not illustrated, and only the exposure head 4, the elevating duct 69, and the cartridge tray 30 are illustrated. FIGS. 30 and 31 only illustrate a cross section of the front drum bearing 26, and the rear drum bearing 26 has the same shape.

The positioning pin 45B and the positioning pin 45F are provided in the housing 54 in order to ensure a distance between the surface of the photosensitive drum 2 and the light emission surface of the lens array 52 of the exposure head 4 with high accuracy. The positioning pins 45F and 45B are provided in the housing 54 in order to fix an angle of the exposure head 4.

Diameters of tips of the positioning pin 45F and the positioning pin 45B on a side facing the drum bearing 26 and widths of the engagement portion 26F and the engagement portion 26B of the drum bearing 26 are controlled with high accuracy. As a result, positioning in a direction orthogonal to the optical axis direction of the exposure head 4 and a direction orthogonal to the axial direction of the photosensitive drum 2 can be performed with high accuracy. The positioning pin 45F and the positioning pin 45B are not in contact with the drum bearing 26 in the axial direction of the photosensitive drum 2, and are positioned by a positioning member (not illustrated).

Further, a pressing position where an engagement boss 66 presses the elevating duct 69, an abutment position between the positioning pin 45F and the positioning pin 45B and the engagement portion 26F and the engagement portion 26B, and a center position of the photosensitive drum 2 are arranged on substantially the same straight line as indicated by a line with alternating long and short dashes in FIG. 30. With such arrangement, the exposure head 4 is pressed toward the center of the photosensitive drum 2, so that an unnecessary turning moment is not applied to the elevating duct 69. Therefore, a component that promotes inclination of the exposure head 4 with respect to the photosensitive drum 2 can be eliminated from a pressing force for pressing the exposure head 4, and positioning accuracy and stability in a repeated attachment and detachment operation can be improved.

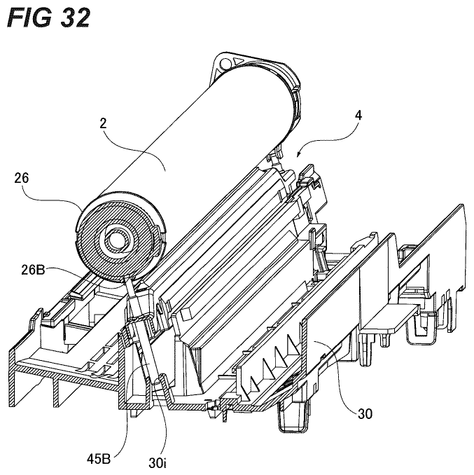

As illustrated in FIGS. 31 and 32, lower end peripheral surfaces of the positioning pin 45F and the positioning pin 45B are fitted to the auxiliary fitting portion 30h and the auxiliary fitting portion 30i of the cartridge tray 30. As a result, even when a slight turning moment occurs due to a weight, a surface property, a dimensional error, or the like of a component, the positioning accuracy can be improved, and a stable repeated attachment and detachment operation can be achieved.

### Method for Manufacturing Exposure Head

A method for manufacturing the exposure head 4 according to the embodiment of the present invention will be described in detail with reference to FIGS. 10 to 12 and FIGS. 14 to 18.

First, the board 50 is inserted through the second opening portion 54b of the housing 54.

Next, the board 50 and the extending portion 54L and the extending portion 54R are fixed by the first adhesive 77a and the second adhesive 77c in a state in which the board 50 is separated from the extending portion 54L and the extending portion 54R. At this time, a position of the board 50 in a focusing direction is adjusted by a jig (not illustrated).

In addition, the lens array 52 and the flat surface portion 54U are fixed by the fourth adhesive 77b and the fifth adhesive 77d in a state in which the lens array 52 is inserted into the first opening portion 54a and in a state in which the lens array 52 is separated from the flat surface portion 54U. At this time, a position and an inclination of the lens array 52 in the focusing direction are adjusted by a jig (not illustrated) such that a distance in the focusing direction between all the LED chips 53 mounted on the board 50 and the lens array 52 has a predetermined value.

After the position of the board 50 is adjusted and the board 50 is fixed to the housing 54, a gap between the board 50 and the extending portions 54L and 54R is sealed with the third adhesive 59a. As a result, it is possible to prevent the LED 51 from being contaminated by the toner or dust from the outside.

Further, after the position of the lens array 52 is adjusted and the lens array 52 is fixed to the housing 54, a gap between the lens array 52 and the flat surface portion 54U is sealed with the sixth adhesive 59b. As a result, it is possible to reduce a possibility that dust such as the toner flows from the gap between the lens array 52 and the flat surface portion 54U and the light emitted from the LED 51 is blocked by the dust.

In the exposure head 4 manufactured by the above manufacturing method, the board 50 and the lens array 52 are held by the housing 54, so that the LED 51 and an incident surface 506b of the lens face each other. As a result, the light emitted from the LED 51 is incident on the incident surface 506b of the lens and then emitted from an emission surface 506a of the lens toward the photosensitive drum 2.

Here, the light emitted from the plurality of LEDs 51 may pass through one same lens. In addition, the light emitted from one LED 51 can pass through a plurality of lenses because the light travels radially. That is, the light emitted from the plurality of LEDs 51 passes through some of the plurality of lenses 521 of the lens array 52 to expose the photosensitive drum 2.

### Effects of Configurations of Image Forming Apparatus and Exposure Head

Effects of the configurations of the image forming apparatus 100 and the exposure head 4 according to the embodiment of the present invention will be described in detail.

In the adhesion and sealing mechanism between the housing 54, and the board 50 and the lens array 52, the second adhesive 77c, which is a photocurable resin that can be cured in a short time even at room temperature, is used when temporarily fixing the housing 54 and the board 50. Further, the fifth adhesive 77d, which is a photocurable resin that can be cured in a short time even at room temperature, is used when temporarily fixing the housing 54 and the lens array 52. As a result, when fixing the board 50 and the lens array 52 to the housing 54 in a state of being separated from each other, it is possible to shorten a time for holding the respective components such as the housing 54, the board 50, and the lens array 52 by a tool or the like.

The first adhesive 77a, which is a thermosetting resin, is used when permanently fixing the housing 54 and the board 50. The fourth adhesive 77b, which is a thermosetting resin, is used when permanently fixing the housing 54 and the lens array 52. As a result, it is possible to increase positional accuracy when or after fixing the board 50 and the lens array 52 to the housing 54 in a state of being separated from each other, and it is possible to increase rigidity of the exposure head 4 and to improve a resistance to temperature changes.

In addition, as the first adhesive 77a, the fourth adhesive 77b, the second adhesive 77c, and the fifth adhesive 77d are provided at equal intervals in the longitudinal direction, the housing 54, the board 50, and the lens array 52 can be fixed in a stable state.

In addition, the first adhesive 77a, the fourth adhesive 77b, the second adhesive 77c, and the fifth adhesive 77d are provided at symmetrical positions in the lateral direction with respect to the center of the board 50 in the lateral direction. As a result, the housing 54, the board 50, and the lens array 52 can be fixed in a stable state.

Here, various electric components such as a drive integrated circuit (IC), a resistor, a capacitor, a thermistor, and the FFC connector 57 are mounted on the lower surface of the board 50. A thermosetting resin and a photocurable resin shrink during curing, or thermally expand or shrink when a temperature change occurs after curing. In a case where such a thermosetting resin or a photocurable resin is attached to the electric component, there is a possibility that stress or strain occurs in the attached electric component and damages the electric component, or imaging characteristics deteriorate due to deformation of the board 50.

Therefore, it is possible to prevent the damage of the electric component and the deterioration of the imaging characteristics by shifting the positions of the first adhesive 77a and the second adhesive 77c in the longitudinal direction from strict equal intervals according to the position where the electric component is mounted with respect to the board 50.

Specifically, it is possible to prevent the damage of the electric component and the deterioration of the imaging characteristics by providing the first adhesive 77a and the second adhesive 77c at positions in the longitudinal direction in a range not overlapping the electric component when viewed from the lateral direction of the board 50.

In addition, when the FFC 58 is inserted into and removed from the FFC connector 57, the exposure head 4 is deformed or damaged by insertion and removal resistances of the FFC 58 or the gripping of the housing 54, which may deteriorate the imaging characteristics. Therefore, by disposing the first adhesive 77a near one end portion of the FFC connector 57 in the longitudinal direction and disposing the second adhesive 77c near the other end portion of the FFC connector 57 in the longitudinal direction, a load generated by the gripping of the housing 54 can be supported by the housing 54.

Here, in a case where only the adhesion points of the first adhesive 77a are disposed near both ends of the FFC connector 57 in the longitudinal direction, a pitch of the adhesion points of the second adhesive 77c in the longitudinal direction is increased, which may reduce the rigidity at the time of temporary fixing. Therefore, it is desirable that the first adhesive 77a is disposed near one end portion of the FFC connector 57 in the longitudinal direction, and the second adhesive 77c is disposed near the other end portion of the FFC connector 57. In addition, a distance between the first adhesive 77a and the FFC connector 57 and a distance between the second adhesive 77c and the FFC connector 57 are desirably within a range of 2 to 10 mm.

In the present embodiment, the first adhesive 77a is disposed near a front end portion of the FFC connector 57, and the second adhesive 77c is disposed near a rear end portion of the FFC connector 57. However, the present invention is not limited thereto, and the second adhesive 77c may be disposed near the front end portion of the FFC connector 57, and the first adhesive 77a may be disposed near the rear end portion of the FFC connector 57.

In addition, at least one adhesion point of the fourth adhesive 77b for permanently fixing the housing 54 and the lens array 52 is disposed at a position overlapping the FFC connector 57 in the up-down direction when viewed from the lateral direction of the board 50. As a result, when the FFC 58 is inserted into and removed from the FFC connector 57, it is possible to suppress the deformation of the housing 54 when both end portions of a portion of the housing 54 where the FFC connector 57 is mounted on the board 50 in the lateral direction are gripped.

In addition, as a low-viscosity moisture-curable resin is used as the third adhesive 59a, the third adhesive 59a can be applied according to shapes of the first adhesive 77a and the second adhesive 77c. As a result, the third adhesive 59a can enter the gap between the extending portion 54L of the housing 54 and the board 50 and the gap between the extending portion 54R of the housing 54 and the board 50, so that the gaps can be reliably sealed.

Similarly, as a low-viscosity moisture-curable resin is used as the sixth adhesive 59b, the sixth adhesive 59b can be applied according to shapes of the fourth adhesive 77b and the fifth adhesive 77d. As a result, the sixth adhesive 59b can enter the gap between the extending portion 54L of the housing 54 and the lens array 52 and the gap between the extending portion 54R of the housing 54 and the lens array 52, so that the gaps can be reliably sealed.

In addition, as a moisture-curable resin is used as the third adhesive 59a and the sixth adhesive 59b, the third adhesive 59a and the sixth adhesive 59b can be easily cured without using a special device for curing in a normal temperature and normal humidity environment.

In the present embodiment, the adhesion points of the first adhesive 77a that is made of a thermosetting resin and fixes the board 50 and the housing 54 in a separated state are provided at a plurality of positions in the longitudinal direction of the board 50. In addition, the third adhesive 59a whose type is different from that of the first adhesive 77a and which fixes the board 50 and the housing 54 in a separated state at least between the adhesion points of the first adhesive 77a adjacent to each other in the longitudinal direction of the board 50 is provided. As a result, favorable imaging characteristics can be obtained and high rigidity can be achieved.

In the present embodiment, the adhesion points of the fourth adhesive 77b that is made of a thermosetting resin and fixes the lens array 52 and the housing 54 in a separated state are provided at a plurality of positions in the longitudinal direction of the lens array 52. In addition, the sixth adhesive 59b whose type is different from that of the fourth adhesive 77b and which fixes the lens array 52 and the housing 54 in a separated state at least between the adhesion points of the fourth adhesives 77b adjacent to each other in the longitudinal direction of the board 50. As a result, favorable imaging characteristics can be obtained and high rigidity can be achieved.

According to the present embodiment, the housing 54 and the board 50 are fixed by the first adhesive 77a made of a thermosetting resin and the third adhesive 59a of a type different from that of the first adhesive 77a, so that the exposure head 4 can have high rigidity.

According to the present embodiment, the housing 54 and the lens array 52 are fixed by the fourth adhesive 77b made of a thermosetting resin and the sixth adhesive 59b of a type different from that of the fourth adhesive 77b, so that the exposure head 4 can have high rigidity.

It goes without saying that the present invention is not limited to the above-described embodiments, and various modifications can be made without departing from the gist of the present invention.

Specifically, in the above embodiment, the bottom exposure method in which the photosensitive drum 2 is exposed from below is used, but the present invention is not limited thereto, and a top exposure method in which the photosensitive drum 2 is exposed from above may be used.

In the above embodiment, an intermediate transfer method using the intermediate transfer belt 9 is used, but the present invention is not limited thereto, and a direct transfer method of directly transferring from the photosensitive drum 2 to the recording sheet P may be used.

Furthermore, in the above embodiment, the positions of the housing 54 and the board 50 and the positions of the housing 54 and the lens array 52 are adjusted, but the present invention is not limited thereto, and the board 50 may be positioned by abutting on the housing 54, and only the positions of the housing 54 and the lens array 52 may be adjusted. Alternatively, the lens array 52 may be positioned by abutting on the housing 54, and only the positions of the housing 54 and the board 50 may be adjusted. In a configuration in which positioning is performed by abutting on the housing 54, an elastic modulus of an adhesive may be low, and thus a thermosetting resin may be used only for fixing the board 50 or the lens array 52 whose position is adjusted with respect to the housing 54.

In the above embodiment, the board 50 is fixed to the housing 54 only by the first adhesive 77a, the third adhesive 59a, and the second adhesive 77c. However, the present invention is not limited thereto, and a heat sink or a reinforcing member of a board assembly unitized by being fixed to an elongated heat sink or reinforcing member may be fixed to the housing 54 by using the first adhesive 77a, the second adhesive 77c, and the third adhesive 59a. At this time, the heat sink or the reinforcing member is formed of aluminum, iron, resin, or the like.

In the above embodiment, the moisture-curable resin is used as the third adhesive 59a and the sixth adhesive 59b, but the present invention is not limited thereto, and a resin different from the thermosetting resin other than the moisture-curable resin may be used as the third adhesive 59a and the sixth adhesive 59b.

In the above embodiment, the housing 54 and the board 50 and the lens array 52 are fixed in a state in which the housing 54 and both of the board 50 and the lens array 52 are separated from each other. However, the present disclosure is not limited thereto, and the housing 54 and the board 50 and the lens array 52 may be fixed in a state in which the housing 54 and only one of the board 50 and the lens array 52 are separated from each other.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2024-074286, filed May 1, 2024, which is hereby incorporated by reference herein in its entirety.

What is claimed is:

1. An exposure head configured to expose a photosensitive member, the exposure head comprising:
a light emitting chip including a plurality of light emitting portions arranged in a rotational axis direction of the photosensitive member and configured to emit light to expose the photosensitive member;
a board on which the light emitting chip is mounted;
a lens configured to condense the light emitted by the light emitting chip onto a surface of the photosensitive member;
a housing configured to hold the board and the lens;
a first adhesive configured to make the housing and the board adhere to each other, the first adhesive being cured at a first rate and having a cured elastic modulus of a first elastic modulus; and
a second adhesive configured to make the housing and the board adhere to each other, the second adhesive being cured at a second rate and having a cured elastic modulus of a second elastic modulus, wherein
the second rate is higher than the first rate, and
the first elastic modulus is higher than the second elastic modulus.

2. The exposure head according to claim 1, wherein the first adhesive has a property of being cured when applied with heat.

3. The exposure head according to claim 2, wherein the second adhesive has a property of being cured by irradiation with light.

4. The exposure head according to claim 1, further comprising a third adhesive provided in a longitudinal direction of the board and configured to seal between the board and the housing.

5. The exposure head according to claim 4, further comprising:
a fourth adhesive configured to make the housing and the lens adhere to each other, the fourth adhesive being cured at a third rate and having a cured elastic modulus of a third elastic modulus; and
a fifth adhesive configured to make the housing and the lens adhere to each other, the fifth adhesive being cured at a fourth rate and having a cured elastic modulus of a fourth elastic modulus.

6. The exposure head according to claim 5, wherein
the fourth rate is higher than the third rate, and
the third elastic modulus is higher than the fourth elastic modulus.

7. The exposure head according to claim 1, wherein the first adhesive makes the board and the housing adhere to each other at a plurality of points whose positions are different from each other in a longitudinal direction of the housing.

8. The exposure head according to claim 7, wherein the second adhesive is applied between adhesion points of the first adhesive that are adjacent to each other in the longitudinal direction.

9. The exposure head according to claim 8, wherein the second adhesive makes the board and the housing adhere to each other at a plurality of points whose positions are different from each other in the longitudinal direction.

10. The exposure head according to claim 9, wherein the first adhesive is applied between adhesion points of the second adhesive that are adjacent to each other in the longitudinal direction.

11. The exposure head according to claim 1, wherein the plurality of light emitting portions is an organic electro-luminescence (EL).
